(19) United States
(12) Patent Application Publication
(10) Pub. No.: US 2004/0236689 A1
(43) Pub. Date: Nov. 25, 2004

(54) Benefit redistributing method, benefit managing apparatus, terminal equipment and computer-readable storage medium

(75) Inventor: Kouzou Matsuyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/876,701

(22) Filed: Jun. 28, 2004

Related U.S. Application Data
(63) Continuation of application No. PCT/JP02/00716, filed on Jan. 30, 2002.

(51) Int. Cl. G06F 17/60

(52) U.S. Cl. 705/42

(57) ABSTRACT

A benefit redistributing method gives a first benefit to a customer depending on a financial transaction between the customer and a banking establishment using a terminal equipment within an arbitrary location, gives a second benefit to the customer depending on a use of a service and/or a purchase of an item by the customer within the arbitrary location, where the first and second benefits are issued by mutually different entities, and manages the first and second benefits and provides a second benefit in exchange for the first benefit or, provides a first benefit in exchange for the second benefit, to the user depending on a selection made by the user.

### BACKGROUND OF THE INVENTION

This application claims the benefit of an International Patent Application No.PCT/JP02/00716 filed Jan. 30, 2002, in the Japanese Patent Office, the disclosure of which is hereby incorporated by reference.

1. Field of the Invention

The present invention generally relates to benefit redistributing methods, benefit managing apparatuses, terminal equipments and storage media, and more particularly to a benefit redistributing method, a benefit managing apparatus and a terminal equipment which redistribute benefits (or privileges) with respect to a financial transaction, and to a computer-readable storage medium which stores a program for causing a computer to carry out such a redistribution of benefits.

2. Description of the Related Art

Conventionally, there is a known system employed by banking establishments to give preferential treatments to customers depending on the business relationships with the customers. For example, the preferential treatments may include preferential rates for remittance services, ATM services provided before or after business hours, and interests for savings and loans. The business relationships with the customers may include automatic receipt of salary and pension remittances, various loans, automatic transfer of utility charges, and balances of savings and loans. In addition, a system for redistributing points to customers from the banking establishment with respect to a financial transaction has been proposed in a Japanese Laid-Open Patent Application No.8-241356, for example.

In credit card businesses, there is a known system which redistributes points to customers depending on the use of their credit cards, so that the customers may exchange the gained points with an item, gift certificate or the like.

Further, in retail trade, there is a known system which redistributes points to customers depending on a purchase of an item in cash or by credit card, so that the customers may exchange the gained points with a gift certificate or the like.

However, according to the conventional systems, when a customer uses an ATM within a shopping mall to make a deposit or withdrawal, for example, the customer can receive a benefit from the banking establishment but cannot receive a benefit from the shopping mall, that is, a location owner who owns the shopping mall. In addition, when the customer purchases an item in a shop within the shopping mall, the customer can receive a benefit from the shop or the shopping mall, but cannot use the benefit in combination with the benefit received from the banking establishment, and cannot use the benefit received from the bank in combination with the benefit received from the shop or the shopping mall. In other words, the benefit received from the shop or shopping mall cannot be used as the benefit received from the banking establishment, and vice versa.

Hence, according to the conventional systems, there is no association of services among the customer, the banking establishment and the location owner. For this reason, from the point of view of the customer, the benefit received from the banking establishment and the benefit received from the location owner cannot be used together in combination, and there was a problem in that the benefits do not appear as attractive as the banking establishment and the location owner would like to them to appear. On the other hand, from the point of view of the banking establishment and the location owner, it is difficult to present the benefits to the customers in a sufficiently attractive or appealing manner such that the use of the services and the purchase of the items may be promoted.

### SUMMARY OF THE INVENTION

Accordingly, it is a general object of the present invention to provide a novel and useful benefit redistributing method, benefit managing apparatus, terminal equipment and computer-readable storage medium, in which the problems described above are suppressed.

Another and more specific object of the present invention is to provide a benefit redistributing method, a benefit managing apparatus, a terminal equipment and a computer-readable storage medium, which enable association of services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

Still another object of the present invention is to provide a benefit redistributing method comprising the steps of giving a first benefit to a customer depending on a financial transaction between the customer and a banking establishment using a terminal equipment within an arbitrary location; giving a second benefit to the customer depending on a use of a service and/or a purchase of an item by the customer within the arbitrary location, the first and second benefits being issued by mutually different entities; and managing the first and second benefits and providing a second benefit in exchange for the first benefit or, providing a first benefit in exchange for the second benefit, to the user depending on a selection made by the user. According to the benefit redistributing method of the present invention, it is possible to associate services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

A further object of the present invention is to provide a terminal equipment provided within a location, comprising a part configured to perform a financial transaction between a customer and a banking establishment; a part configured to input service information related to a service used by the customer within the location and/or purchase information related to a purchase made by the customer within the location; a part configured to notify to the customer a first benefit given to the customer from the banking establishment depending on the transaction made by the customer and a second benefit given to the customer from a location manager depending on the service used and/or the purchase made by the customer within the location; and a part configured to send an instruction to convert the first benefit into a second benefit or the second benefit into a first benefit based on a request from the customer, the instruction being set to a host via a communication line. According to the terminal equipment of the present invention, it is possible to associate services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

Another object of the present invention is to provide a computer-readable storage medium which stores a program for causing a computer to issue first and second benefits as points and centrally control the points, the program comprising a procedure causing the computer to issue points of the first benefit to a customer from a banking establishment depending on a financial transaction between the customer and the banking establishment using a terminal equipment within an arbitrary location; a procedure causing the computer to issue points of the second benefit to the customer from a location manager depending on a use of a service and/or a purchase of an item by the customer within the arbitrary location; a procedure causing the computer to store the points of the first benefit and the points of the second benefit in a storage unit for each customer; and a procedure causing the computer to convert the first benefit stored in the storage unit into a second benefit or to convert the second benefit stored in the storage unit into a first benefit, by referring to a table that is configured to convert the first benefit into the second benefit or to converting the second benefit into the first benefit, based on a request from the customer. According to the computer-readable storage medium of the present invention, it is possible to associate services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

The arbitrary location may be selected from a group consisting of real locations and virtual locations on the Internet.

Still another object of the present invention is to provide a benefit managing apparatus, coupled to a computer of a bank establishment and to a terminal equipment provided within a location, for managing benefits depending on transactions made by a customer, the benefit managing apparatus comprising a storage unit configured to store a first benefit issued depending on a financial transaction that is made by use of the terminal equipment within the location and a second benefit issued depending on a use of a service and/or a purchase of an item within the location, for each customer; a table configured to convert the first benefit into a second benefit or to convert the second benefit into a first benefit; and a controller configured to convert the first benefit of a user stored in the storage unit into the second benefit or to convert the second benefit of the user stored in the storage unit into the first benefit, by referring to the table based on a request from the customer. According to the benefit managing apparatus of the present invention, it is possible to associate services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

A further object of the present invention is to provide a benefit managing apparatus, coupled to a computer of a banking establishment and to each terminal equipment provided within a plurality of locations, for managing benefits depending on transactions made by a customer, the benefit managing apparatus comprising a storage unit configured to store a first benefit issued depending on a financial transaction that is made by use of a terminal equipment within one of the plurality of locations, and a second benefit issued depending on a use of a service and/or a purchase of an item within the plurality of locations independently for each of the plurality of locations, the first and second benefits being stored in the storage unit for each customer; a table configured to convert the first benefit into a second benefit or to convert the second benefit within a specific location into a second benefit within an other location; and a controller configured to convert the first benefit of a user stored in the storage unit into the second benefit or to convert the second benefit of the user within the specific location stored in the storage unit into the second benefit within the other location, by referring to the table based on a request from the customer. According to the benefit managing apparatus of the present invention, it is possible to associate services among customers, banking establishments and location managers, and from the point of view of the customer, enable benefits received from a banking establishment and a location owner to be used together in combination so as to maximize advantages of the benefits, and from the point of view of the banking establishment and the location manager, enable the benefits to be presented to the customers in a sufficiently attractive or appealing manner such that the use of services and purchase of items are promoted.

Other objects and further features of the present invention will be apparent from the following detailed description when read in conjunction with the accompanying drawings.

### BRIEF DESCRIPTION OF THE DRAWINGS

FIG. 1 is a diagram showing a structure of a system to which a first embodiment of a benefit redistributing method according to the present invention may be applied;

FIG. 2 is a system block diagram showing a basic structure of a computer;

FIG. 3 is a system block diagram showing a basic structure of a terminal equipment;

FIG. 4 is a flow chart for explaining an operation of a CPU of the terminal equipment;

FIG. 5 is a diagram showing an initial menu;

FIG. 6 is a diagram showing a card insertion menu;

FIG. 7 is a diagram showing a member information registration menu;

FIG. 8 is a diagram showing a card extraction menu;

FIG. 9 is a diagram showing a card insertion menu;

FIG. 10 is a diagram showing a personal confirmation menu;

FIG. 11 is a diagram showing a cash remittance selection menu;

FIG. 12 is a diagram showing a petty cash transaction menu;

FIG. 13 is a diagram showing a point/electronic money conversion menu;

FIG. 14 is a diagram showing a petty cash temporary pool menu;

FIG. 15 is a diagram showing a petty cash transaction menu;

FIG. 16 is a diagram showing a continuous deposit and remittance menu;

FIG. 17 is a diagram showing a continuous deposit and remittance menu;

FIG. 18 is a flow chart for explaining a petty cash process;

FIG. 19 is a flow chart for explaining a continuous deposit and remittance process;

FIG. 20 is a flow chart for explaining a deposit switching process;

FIG. 21 is a flow chart for explaining a cash-point conversion process;

FIG. 22 is a diagram showing cash-point conversion menu;

FIG. 23 is a diagram showing a point redistribution menu;

FIG. 24 is a diagram showing an item exchange menu;

FIG. 25 is a diagram showing a point collecting menu;

FIG. 26 is a diagram showing an embodiment of a discount ticket for an XYZ store;

FIG. 27 is a diagram showing an embodiment of a free ticket for the XYZ store;

FIG. 28 is a diagram showing an embodiment of an entry ticket for a gallery;

FIG. 29 is a diagram showing an embodiment of a discount ticket for an amusement park;

FIG. 30 is a diagram showing an embodiment of a special 10%-off discount ticket;

FIG. 31 is a diagram showing an embodiment of a 1-drink service ticket;

FIG. 32 is a diagram showing an embodiment of a special viewing ticket;

FIG. 33 is a diagram showing an embodiment of a special discount viewing ticket;

FIG. 34 is a flow chart for explaining a process of a computer;

FIG. 35 is a flow chart for explaining a process for a case where a terminal equipment is provided at a virtual location on the Internet;

FIG. 36 is a diagram showing an embodiment of a member file;

FIG. 37 is a diagram showing an embodiment of an ASP point file;

FIG. 38 is a diagram showing another embodiment of the ASP point file;

FIG. 39 is a diagram showing still another embodiment of the ASP point file;

FIG. 40 is a diagram showing an embodiment of a location owner point file;

FIG. 41 is a diagram showing another embodiment of the location owner point file;

FIG. 42 is a diagram showing an embodiment of a location owner discount file;

FIG. 43 is a diagram showing an embodiment of a location owner item providing file;

FIG. 44 is a diagram showing an embodiment of a point exchange file;

FIG. 45 is a diagram showing an embodiment of a calendar file;

FIG. 46 is a diagram showing an embodiment of an interest rate file; and

FIG. 47 is a diagram showing an embodiment of a deposit account and remittance account file.

### DESCRIPTION OF THE PREFERRED EMBODIMENTS

A description will be given of embodiments of a benefit redistributing method, a benefit managing apparatus, a terminal equipment and a computer-readable storage medium according to the present invention, by referring to the drawings.

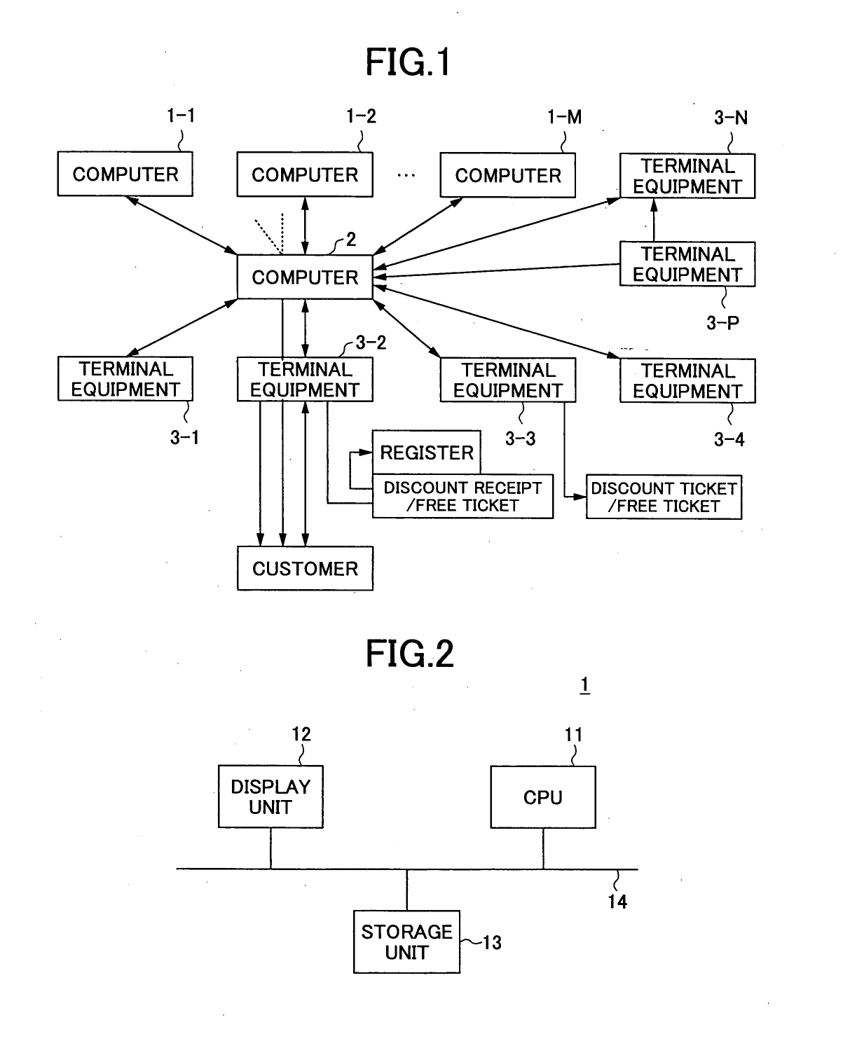

FIG. 1 is a diagram showing a structure of a system to which a first embodiment of the benefit redistributing method according to the present invention may be applied. The system shown in FIG. 1 includes a plurality of computers 1-1 through 1-M of different banking establishments, a computer 2 of an application service provider, and a plurality of terminal equipments 3-1 through 3-N which may be ATM, CD, KIOSK or the like.

Each of the computers 1-1 through 1-M has a known basic structure in which a CPU 11, a display unit 12 and a storage unit 13 are connected via a bus 14 as shown in FIG. 2, for example. The computer 2 may also have a basic structure similar to that shown in FIG. 2, and illustration and description of the basic structure of the computer 2 will be omitted. The computer 2 forms a benefit redistributing apparatus. A computer program to be executed by a CPU which is within the computer 2 and corresponds to CPU 11, is stored in a storage unit which is within the computer 2 and corresponds to the storage unit 13. This computer program may be prestored in the storage unit, downloaded into the storage unit via a network or, read from a recording medium and downloaded into the storage unit.

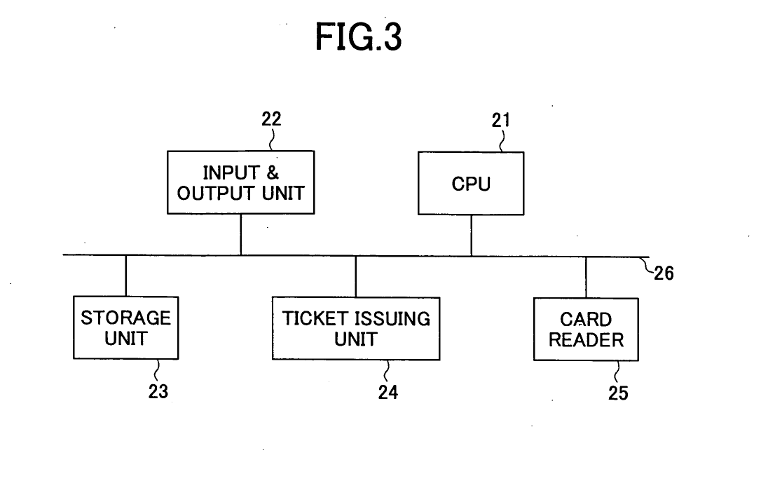

Each of the terminal equipments 3-1 through 3-N has a known basic structure in which a CPU 21, an input and output unit 22, a storage unit 23, a ticket issuing unit 24 and a card reader 25 are connected via a bus 26 as shown in FIG. 3, for example. The input and output unit 22 includes an operation panel such as a keyboard, and a display. The input and output unit 22 may have a structure of a touch panel or the like integrally comprising the operation panel and the display. In addition, the input and output unit 22 may include a voice output unit which outputs a message by voice. When issuing a receipt of a financial transaction, a ticket which will be described later or the like in the form of a recording medium such as paper, the ticket issuing unit 24 includes a printer. On the other hand, when issuing the ticket in the form of a recording medium such as a magnetic card, the ticket issuing unit 24 includes a recording apparatus such as a magnetic recording apparatus. The ticket issuing unit 24 may include both the printer and the recording apparatus. The card reader 25 reads information from a card, such as a cashing (or bank) card of a banking establishment, that is inserted into the card reader 25.

Each of the computers 1-1 through 1-M carries out various financial transactions in response to an operation performed from the terminal equipments 3-1 through 3-N or a terminal equipment 3-P such as the customer's personal computer, portable terminal and portable (or mobile) telephone set. The various financial transactions include deposit and withdrawal, remittance, transfer, cashing, offline debit, electronic money and the like. For example, the terminal equipments 3-1 through 3-N are connected to the computers 1-1 through 1-M via the computer 2 by way of exclusive lines or the like. In addition, the terminal equipment 3-P is connected to the computers 1-1 through 1-M via the computer 2 by way of one or more networks such as the Internet.

The computer 2 issues benefits with respect to each customer depending on financial transactions and the like of each customer, and centrally manages the benefits of each customer. As will be described later, the benefits are issued and managed in units of points. In this embodiment, one computer 2 is provided with respect to all of the computers 1-1 through 1-M, however, one computer 2 may be provided with respect to each group of computers, where each group may be made up of one or a plurality of computers of the computers 1-1 through 1-M. In a case where each banking establishment also performs business as an application service provider, the functions of the computer 2 may be provided within each of the computers 1-1 through 1-M.

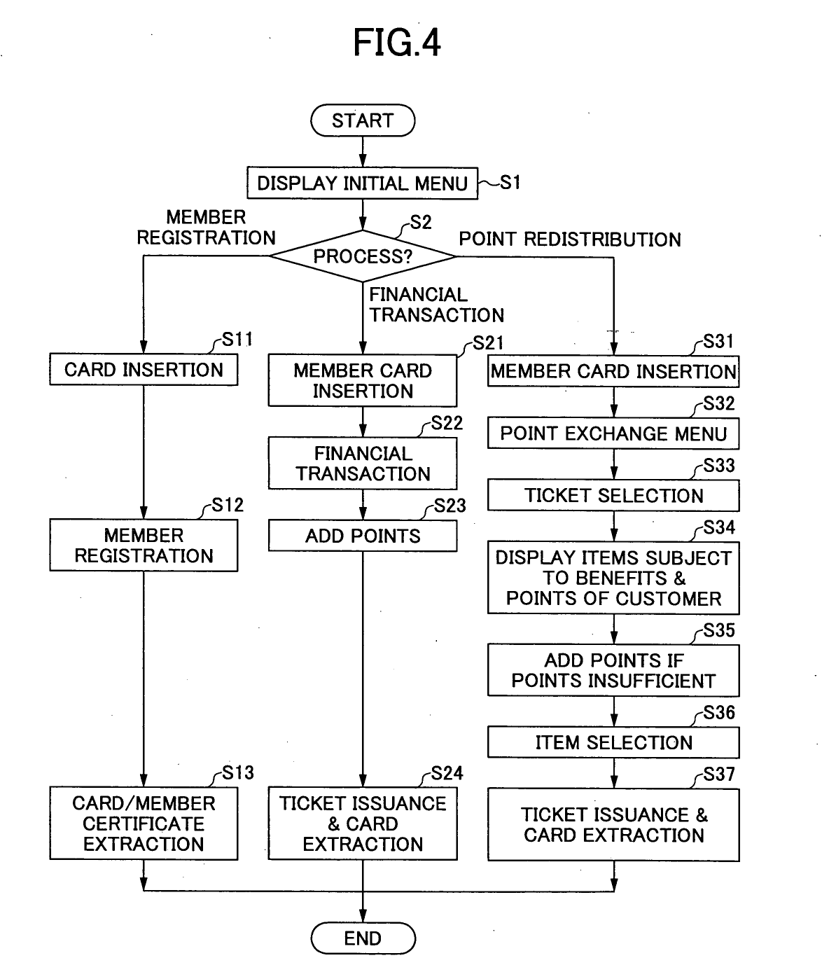

Next, a description will be given of an operation of the terminal equipment 3-N, by referring to FIG. 4. FIG. 4 is a flow chart for explaining an operation of the CPU 21 of the terminal equipment 3-N. It is assumed for the sake of convenience that the terminal equipment 3-N is set up at a real location such as a shopping mall, and that a plurality of banking establishments and a location manager of the real location have an agreement to permit mutual use of the benefits given to the customers by the banking establishments and the location manager. The location manager may be a location owner of the real location.

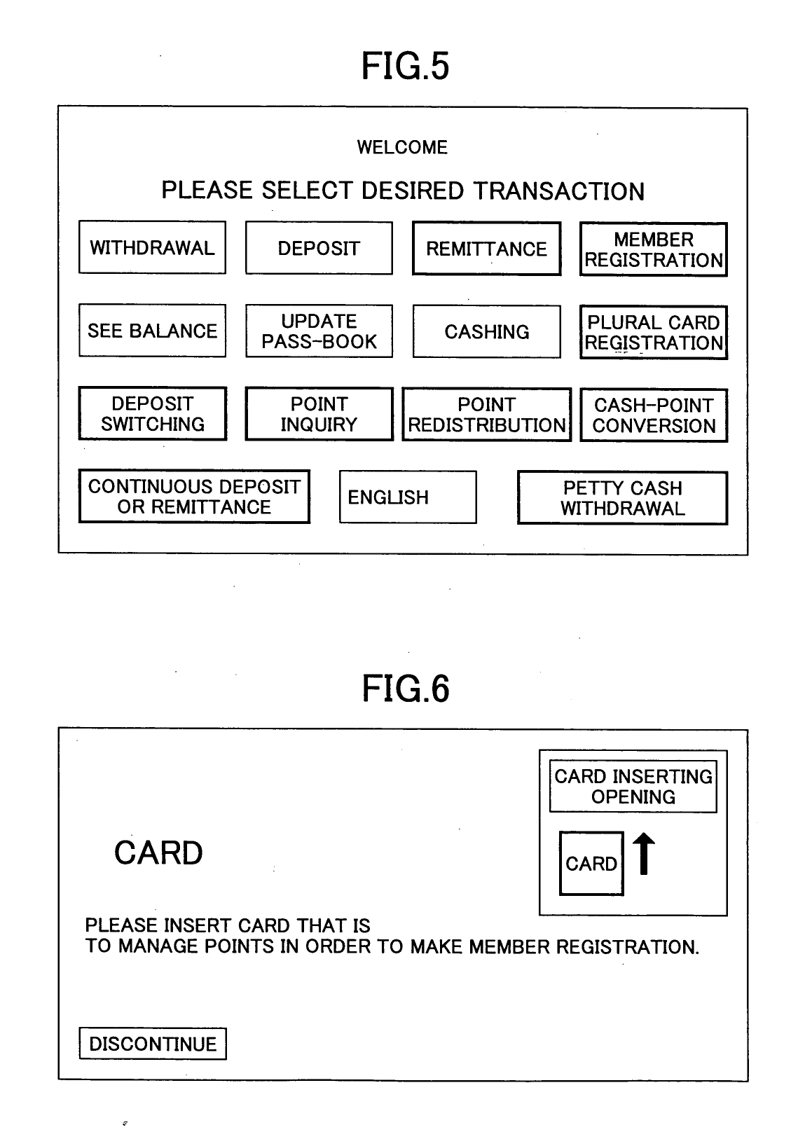

A step S1 shown in FIG. 4 displays an initial menu shown in FIG. 5, for example, on the touch panel of the input and output unit 22 of the terminal equipment 3-N. Buttons for selecting a language to be displayed on the menu, a kind of financial transaction, a member registration and the like are displayed on the initial menu. The customer selects (or pushes) the button of the selected process on the initial menu. A step S2 decides whether or not the process selected on the initial menu is the member registration, financial transaction or point redistribution. If the “member registration” button is selected, the process advances to a step S11. If the “point redistribution” button is selected, the process advances to a step S31. In addition, if a button other than the “member registration” and “point redistribution” buttons is selected and the financial transaction is selected, the process advances to a step S21.

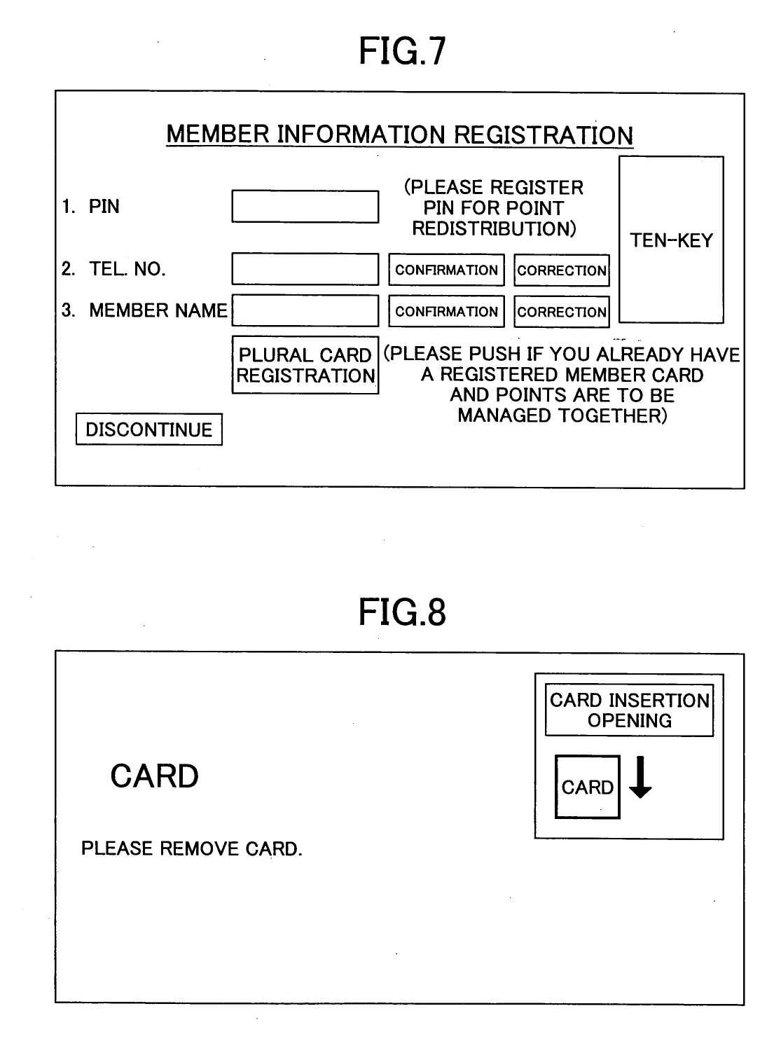

Steps S11 through S13 carry out a member registration process. The step S11 displays a card insertion menu shown in FIG. 6, and urges the customer to insert a card, such as a cashing card of the banking establishment and a credit card. When the customer inserts the card into the card reader 25, a step S12 carries out the member registration. More particularly, the step S12 displays a member information registration menu shown in FIG. 7, and urges the customer to input member information such as a personal identification number (PIN). The PIN is authenticated by a known method based on information read from the card, and if the authentication result confirms the customer, a telephone number and a member's name of the customer are acquired from the computer 1-1, for example, of the corresponding banking establishment and displayed. If the customer wishes to correct the displayed telephone number and/or member's name, a correction may be made by selecting a “correction” button, making the necessary correction and then selecting a “confirmation” button. When the input of the member information ends, a step S13 displays a card extraction menu shown in FIG. 8 and urges the customer to extract (or remove) the card, and the process ends when the card is extracted from the card reader 25.

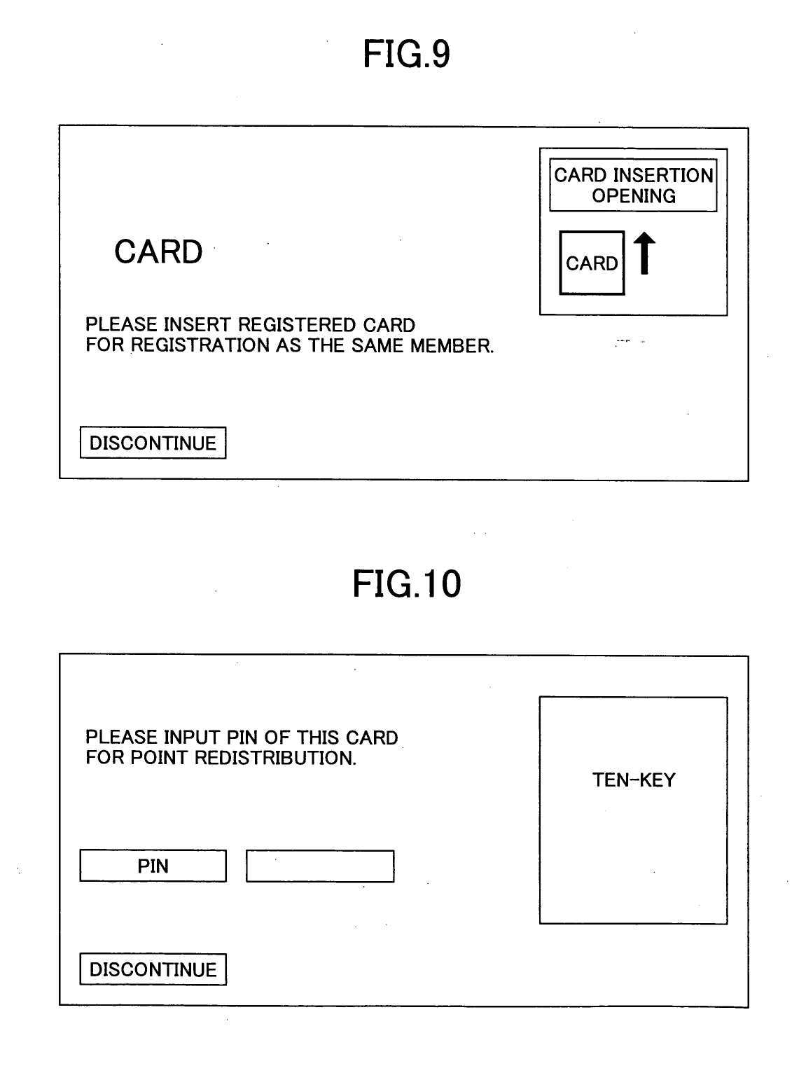

If a “plural card registration” button is selected in the step S12, menus shown in FIGS. 9 and 10 are displayed in the step S12 to urge the customer to make an input, after the card is extracted from the card reader 25, before advancing to the step S13. A card insertion menu shown in FIG. 9 urges the customer to insert another card so as to accept registration of a plurality of cards. For example, if the card inserted first is the cashing card of the banking establishment, the card inserted next is the credit card or the like usable in the shopping mall is inserted next. When the credit card or the like is inserted in this manner, a personal confirmation menu shown in FIG. 10 is displayed, so as to urge the customer to input a PIN to enable personal confirmation of the customer. The PIN is authenticated similarly to the case where the member information input menu shown in FIG. 7 is displayed, and the benefits received by the two cards are managed together if the authentication result confirms the customer. On the other hand, if the “plural card registration” button is not selected in the step S12, the display returns to the initial menu shown in FIG. 5 after the card is extracted from the card reader 25.

Accordingly, cards of accounts in a plurality of banking establishments and other general member's cards may be managed under a single point system (or program). In addition, the point system may be associated with other point systems of external points. When associating point systems, a portion of the points may be transferred from one point system to another for the purpose of exchanging the points with an item or, the entire point redistribution system may be transferred to another point redistribution system. In addition, the method of association itself includes online association, offline association and card association. The online association associates the point system of the banking establishment and the point system of the credit card company, for example, by online, and transfers the points desired by the customer to the member's file of the computer (ASP) 2 so that the customer may receive the redistribution of the points at the terminal equipments 1-1 through 1-N which are connected to the computer 2. The offline association makes the above described transfer of the point system by offline. The card association makes the above described transfer of the point system using a card.

The information that is input and/or acquired during the member registration process is transferred to the computer 2 and centrally managed therein. The benefits of the customers are centrally managed by the computer 2 in units of points. The processes carried out by the computer 2 will be described later.

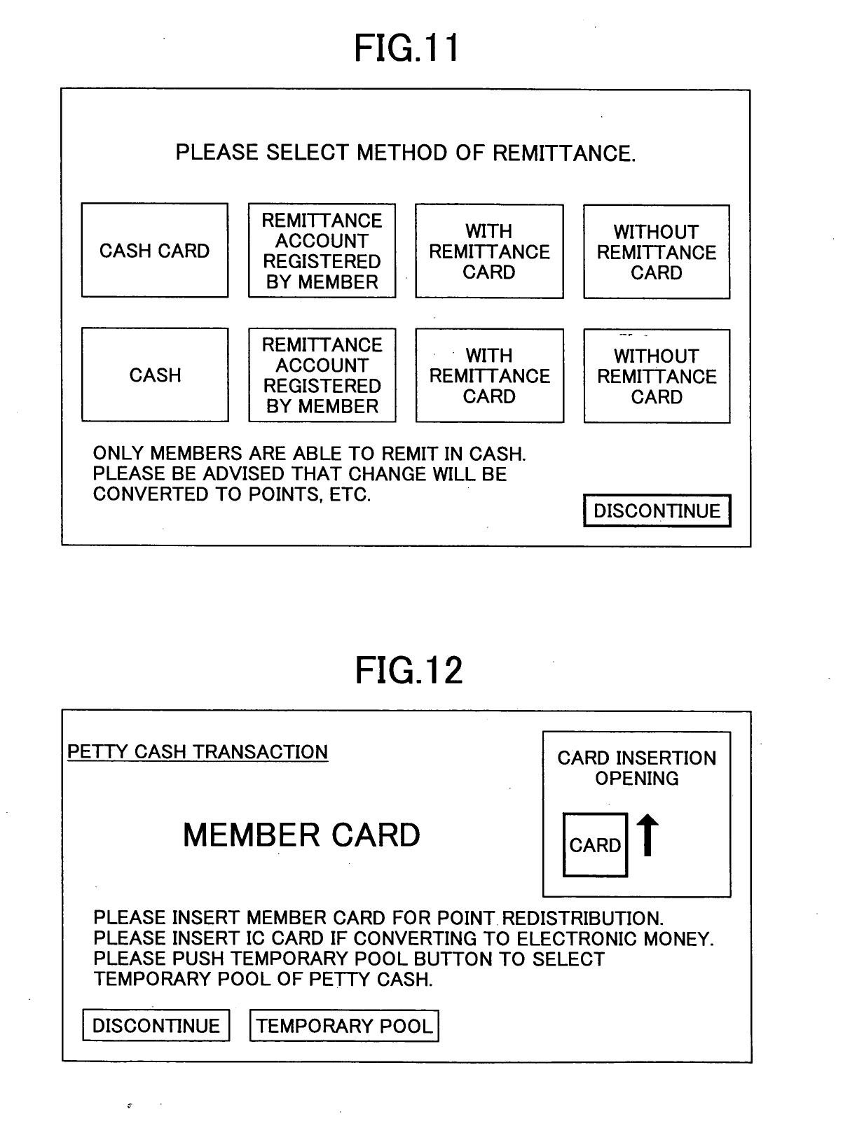

Steps S21 through S24 carry out a point adding process depending on the financial transaction. The step S21 displays a card insertion menu similar to the card insertion menu shown in FIG. 6, and urges the customer to insert the card, such as the cashing card of the banking establishment and the credit card. When the customer inserts the card into the card reader 25, the step S21 displays a member information input menu and urges the customer to input the member information such as the PIN. The PIN is authenticated by a known method based on the information read from the card. If a “remit” button is selected on the initial menu shown in FIG. 5, for example, a cash remittance selection menu shown in FIG. 11 is displayed when the authentication result confirms the customer. The step S22 carries out a financial transaction selected on the cash remittance selection menu. Of the financial transactions selectable on the initial menu shown in FIG. 5, the financial transactions which may be processed similarly to the conventional method will not be described in detail, and a description thereof will be omitted in this specification.

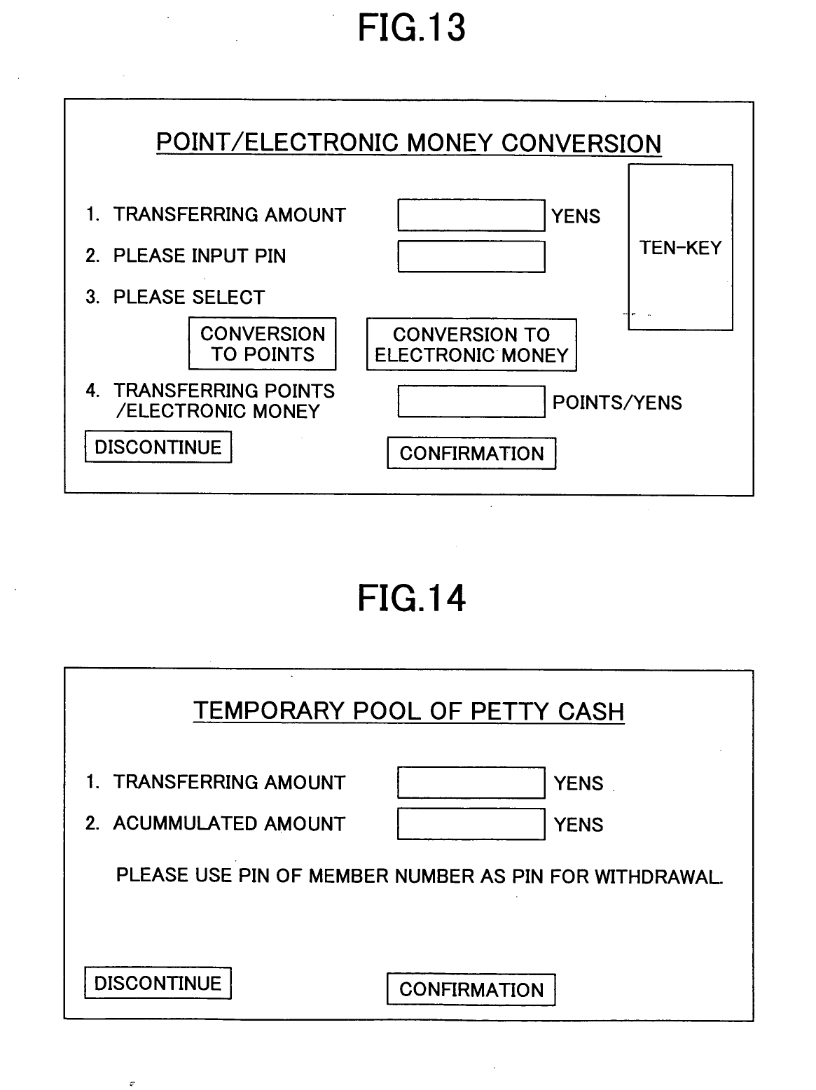

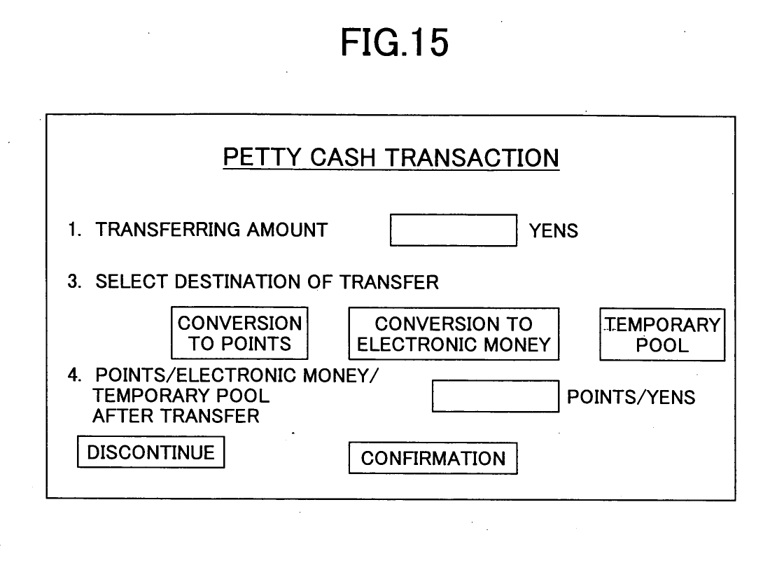

The step S23 adds points with respect to the customer depending on parameters such as contents of the financial transaction carried out in the step S22, a setup location of the terminal equipment 3-N, a transaction time, a transaction time band and the like. Te points may receive interests. For example, when the selected remittance ends, a petty cash transaction menu is displayed, so as to urge the customer to insert a card and to select whether or not a temporary pool is to be made. By employing the petty cash transaction menu, it becomes possible to make a cash remittance even from an ATM or the like that is not provided with a function of handling coins, for example, and it is possible to reduce the cost of the apparatus as well as the running cost of the apparatus. In a case where the card to which the points are to be redistributed and the card which is already inserted for making the financial transaction are the same, there is no need to insert another card. Thereafter, a point or electronic money (point/electronic money) conversion menu shown in FIG. 13 is displayed, so as to urge the customer to input a transferring amount of money, the PIN, the point or electronic money conversion, transferring points or electronic money, and the like. When the temporary pool of the petty cash is selected on the point/electronic money conversion menu, a petty cash temporary pool menu shown in FIG. 14 is displayed to display the transferring amount of money, the accumulated amount of money, and the like. The step S24 issues a discount ticket, a free ticket or the like from the ticket issuing unit 24 depending on the added points, and also displays the card extraction menu shown in FIG. 8 to urge the customer to extract the card from the card reader 25, and the process ends when the customer extracts the card from the card reader 25. The discount ticket, the free ticket or the like issued in the step S24 will be described later. In FIG. 13, the card is ejected from the card reader 25 and the process ends if the “confirmation” button is selected, but the display returns to a petty cash transaction menu shown in FIG. 15 if a “discontinue” button is selected.

On the other hand, if a “petty cash withdrawal” button is selected on the initial menu shown in FIG. 5, the petty cash transaction menu shown in FIG. 15 is displayed, and the step S22 carries out the financial transaction selected on the petty cash transaction menu. In FIG. 15, it is assumed that a transfer destination is the point conversion, the electronic money conversion associated with the point conversion or, the temporary pool. In this case, if the temporary pool of the petty cash is selected on the petty cash transaction menu, the petty cash temporary pool menu shown in FIG. 14 is displayed to display the transferring amount of money, the accumulated amount of money, and the like, similarly to the case described above.

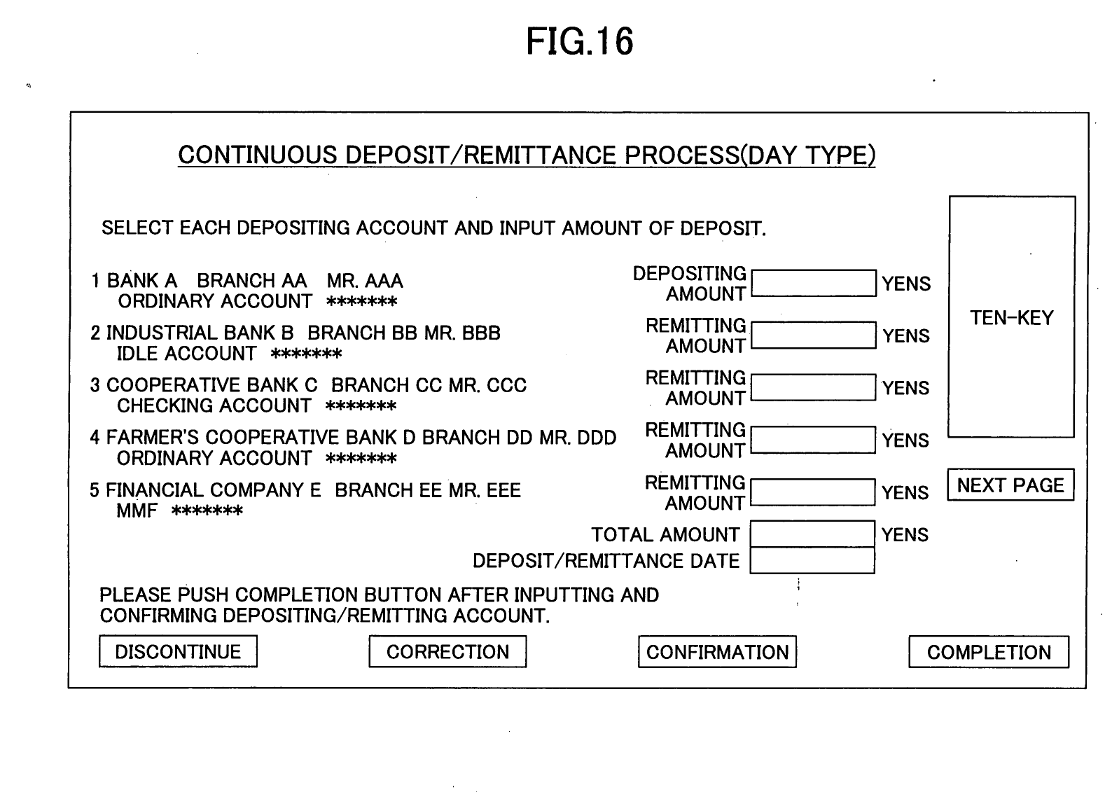

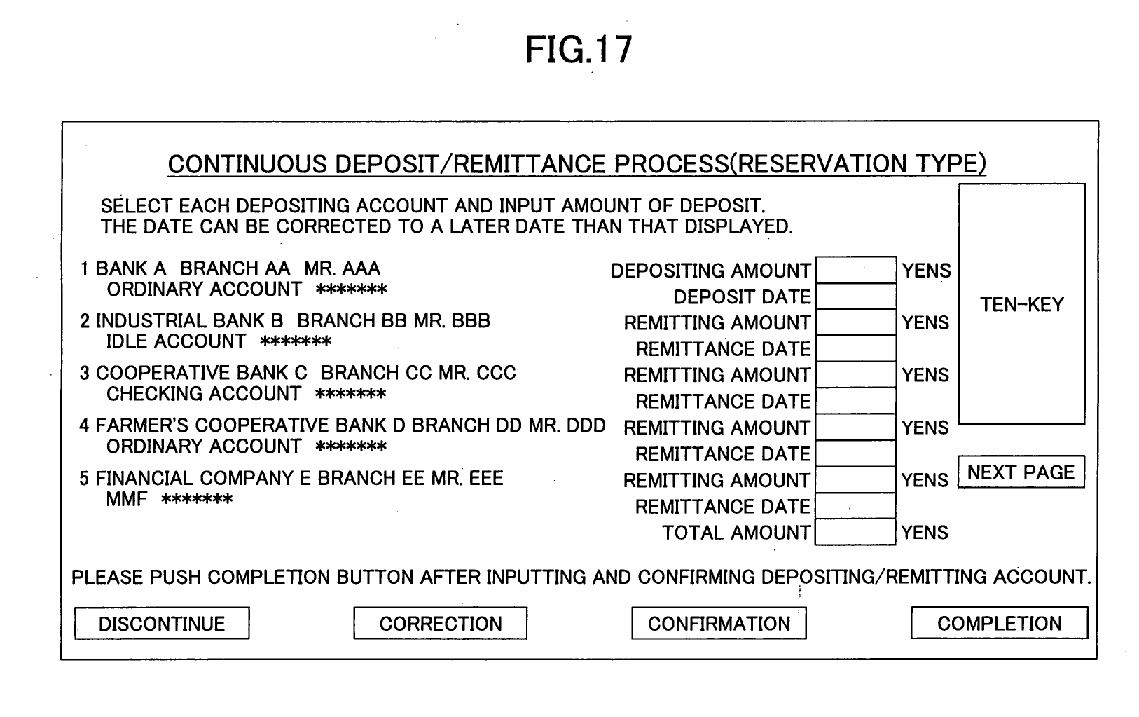

If a “continuous deposit or remittance” button is selected on the initial menu shown in FIG. 5, a continuous deposit and remittance menu shown in FIG. 16 or, a continuous deposit and remittance menu shown in FIG. 17 is displayed, and the step S22 carries out a financial transaction selected on the continuous deposit and remittance menu.

The customer inputs the deposit amount, the remittance amount or the like on the continuous deposit and remittance menu shown in FIG. 16. For the sake of convenience, FIG. 16 shows the continuous deposit and remittance menu for a case where a day deposit and/or a day remittance is made. Of course, the continuous deposit and remittance is not limited to the method which selects from a list as shown in FIG. 16, and it is possible to employ other methods such as a method which takes into consideration the amount of data and the specifying of the terminal equipment 3-N.

The customer inputs the deposit account and the deposit date, the remittance amount and the remittance day or the like on the continuous deposit and remittance menu shown in FIG. 17. Accordingly, it is possible to specify a plurality of deposits and/or the deposit day thereof, and a plurality of remittances and/or the remittance day thereof on the continuous deposit and remittance menu shown in FIG. 17. For the sake of convenience, FIG. 17 shows the continuous deposit and remittance menu for a case where a deferred deposit and/or a deferred remittance is/are to be made on days on or after the next day. Data related to the deferred deposit and/or remittance are managed by the computer 2 or the corresponding computer 1-1, for example of the banking establishment, and the deposit and/or remittance are/is automatically made on the specified day of deposit and/or remittance based on the managed data.

Information that is input or acquired during the point adding process is transferred to the computer 2 and centrally managed by the computer 2. The benefits received by the customers are centrally managed by the computer 2 in units of points. The processes carried out by the computer 2 will be described later.

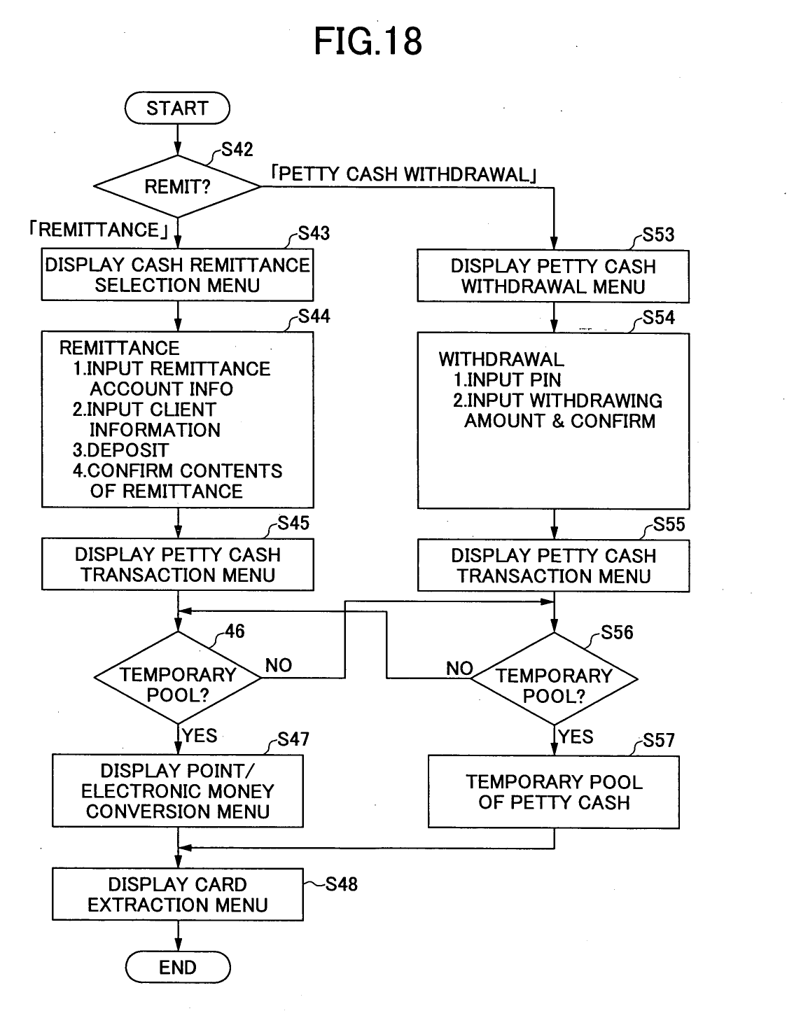

FIG. 18 is a flow chart for explaining a petty cash process. For the sake of convenience, FIG. 18 only shows the petty cash process for a case where the “remit” button or the “petty cash withdrawal” button is selected on the initial menu shown in FIG. 5, and corresponds to a point adding process carried out by the steps S21 through S24 shown in FIG. 4.

In FIG. 18, a step S42 decides whether the “remit” button or the “petty cash withdrawal” button is selected. If the “remit” button is selected, a step S43 displays the cash remittance selection menu shown in FIG. 11, and urges the customer to input the method of remittance and the like. A step S44 carries out a remittance similarly to the conventional remittance, based on the method of remittance and the like which are input. More particularly, the step S44 displays a menu urging the customer to input the remittance account information and the client information, makes a deposit based on the input information, and displays a menu urging the customer to confirm the contents of the remittance.

A step S45 displays the petty cash transaction menu shown in FIG. 12, and urges the customer to insert a card if the card which is already inserted for making the financial transaction is different from the card to which the points are to be redistributed. A step S46 decides whether not the “temporary pool” button is selected on the petty cash transaction menu, and if the decision result in the step S46 is YES, a step S47 displays the point/electronic money conversion menu shown in FIG. 13, and urges the customer to input various information. Then, a step S48 issues the discount ticket, the free ticket or the like from the ticket issuing unit 24, depending on the points that are added based the input information, the financial transaction and the like. In addition, the step S48 displays the card extraction menu shown in FIG. 8, and urges the customer to extract the card from the card reader 25, and the process ends if the card is extracted. If the decision result in the step S46 is NO, the process advances to a step S56 which will be described later.

On the other hand, if the “petty cash withdrawal” button is selected, a step S53 displays a petty cash withdrawal menu similar to that shown in FIG. 12, and urges the customer to insert a card if the card which is already inserted for making the financial transaction is different from the card to which the points are to be redistributed. A step S54 carries out a withdrawal similarly to the conventional withdrawal, based on the information read from the inserted card. More particularly, the step S54 displays a menu urging the customer to input information such as the PIN, withdrawing amount, and confirmation.

A step S55 displays the petty cash transaction menu shown in FIG. 15, and urges the customer to input various information. The step S56 decides whether or not the “temporary pool” button is selected on the petty cash transaction menu, and if the decision result in the step S56 is YES, a step S57 carries out a temporary pool of the petty cash. In addition, the step S48 issues the discount ticket, the free ticket or the like from the ticket issuing unit 24, depending on the points that are added based on the input information, the financial transaction and the like. In addition, the step S48 displays the card extraction menu shown in FIG. 8, and urges the customer to extract the card from the card reader 25, and the process ends if the card is extracted. If the decision result in the step S56 is NO, the process returns to the step S46.

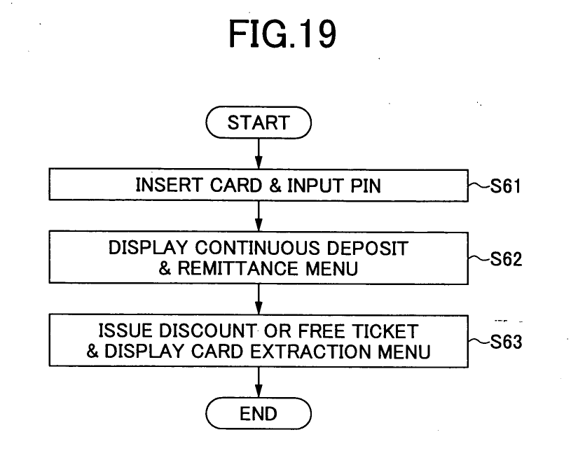

FIG. 19 is a flow chart for explaining a continuous deposit and remittance process. For the sake of convenience, FIG. 19 only shows the continuous deposit and remittance process for a case where a “continuous deposit and remittance” button is selected on the initial menu shown in FIG. 5, and the process shown in FIG. 19 corresponds to the point adding process of the steps S21 through S24 shown in FIG. 4. It is also assumed for the sake of convenience that the deposit account and the remittance account are registered in advance.

In FIG. 19, a step S61 urges the customer to insert the card and to input the PIN and the like if the card which is already inserted for making the financial transaction is different from the card to which the points are to be redistributed. A step S62 displays the continuous deposit and remittance menu shown in FIG. 16 or FIG. 17, to urge the customer to input the deposit amount, the remittance amount, the deposit date, the remittance date and the like and to make a confirmation, and carries out a deposit and/or remittance similarly to the conventional deposit and/or remittance, based on the input information. A step S63 issues the discount ticket, the free ticket or the like from the ticket issuing unit 24, depending on the points that are added based the input information, the financial transaction and the like. In addition, the step S63 displays the card extraction menu shown in FIG. 8, and urges the customer to extract the card from the card reader 25, and the process ends if the card is extracted.

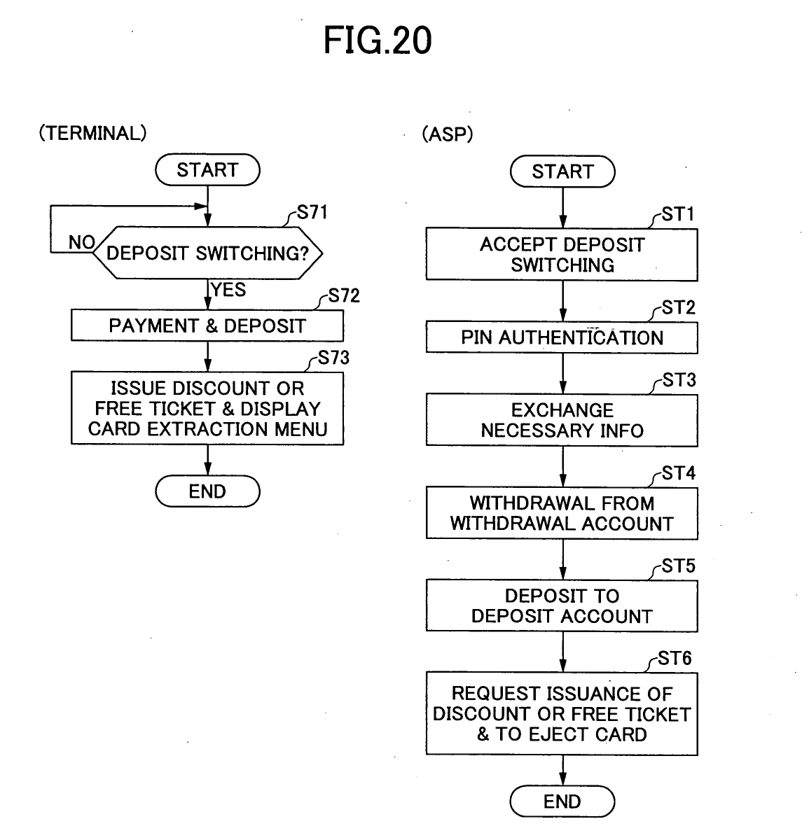

FIG. 20 is a flow chart for explaining a deposit switching process. For the sake of convenience, FIG. 20 shows the deposit switching process for a case where a “deposit switching” button is selected on the initial menu shown in FIG. 5, and the process shown in FIG. 20 corresponds to the point adding process of the steps S21 through S24 shown in FIG. 4. Furthermore, in FIG. 20, the left portion indicates the process of the terminal equipment 3-N, while the right portion indicates the process of the computer 2.

First, a description will be given of the process of the terminal equipment 3-N. A step S71 shown in FIG. 20 decides whether or not the “deposit switching” button is selected on the initial menu shown in FIG. 5. The process advances to a step S72 if the decision result in the step S71 is YES. The step S72 carries out a payment and deposit similarly to the conventional payment and deposit. More particularly, the payment is carried out by displaying a menu which urges the customer to insert a card and to input the PIN and the like, and displaying a menu which urges the customer to input the payment amount, the contents of the payment, to make the final confirmation, so as to carry out a process based on the payment information. The deposit is carried out by displaying a menu which urges the customer to make a manual input, insert a card, and input the deposit account number, a mail address and the like of the deposit account directly, and displays a menu which urges the customer to input the deposit amount, confirm the contents of the deposit, the final confirmation and the like, so as to carry out the process based on the deposit information that is input. A step S73 issues the discount ticket, the free ticket or the like from the ticket issuing unit 24, depending on the points that are added based on the input information, the financial transaction and the like that are input. Moreover, the step S73 displays the card extraction menu shown in FIG. 8 to urge the customer to extract the card from the card reader 25, and the process ends if the card is extracted. Hence, the process of the terminal equipment 3-N is similar to the remittance process using the conventional card which does not make cash deposits.

Next, a description will be given of the process of the computer 2. A step ST1 shown in FIG. 20 accepts the deposit switching from the terminal equipment 3-N if the decision result in the step S71 is YES. A step ST2 carries out a PIN authentication to confirm the customer based on the various information input in the step S72. When the customer is confirmed, a step ST3 exchanges necessary information with a computer 1-i of the banking establishment having the deposit account and/or a computer 1-j of the banking establishment having the withdrawal account, based on the various information input in the step S72, where i=1 to M, j=1 to M, and i≠j. In the case of a payment, a step ST4 carries out a known withdrawal from the computer 1-j having the withdrawal account. In the case of a deposit, a step ST5 carries out a known deposit to the computer 1-i having the deposit account. A step ST6 requests the terminal equipment 3-N to issue the discount ticket, the free ticket or the like and to eject the card, depending on the points that are added based on the payment and/or deposit and the various information input in the step S72, and the process ends. Accordingly, the process of the computer 2 does not perform the conventional remittance, but consecutively performs the withdrawal from the computer 1-j of the banking establishment having the withdrawal account and the deposit to the computer 1-i of the banking establishment having the deposit account.

The deposit switching described above is convenient when the person making the deposit is known in advance and there is no need to indicate the person making the deposit, such as when switching deposits between the bank accounts of the customer himself, and making deposits to a securities account, insurance account, an allowance account and the like.

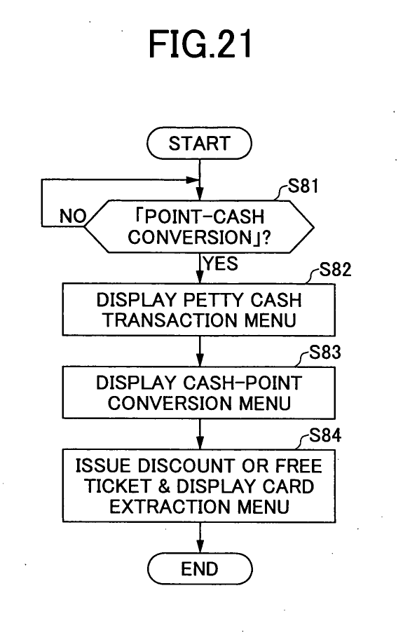

FIG. 21 is a flow chart for explaining a cash-point conversion process. For the sake of convenience, FIG. 21 shows the cash-point conversion process for a case where a “cash-point conversion” button is selected on the initial menu shown in FIG. 5, and the process shown in FIG. 21 corresponds to the point adding process of the steps S21 through S24 shown in FIG. 4.

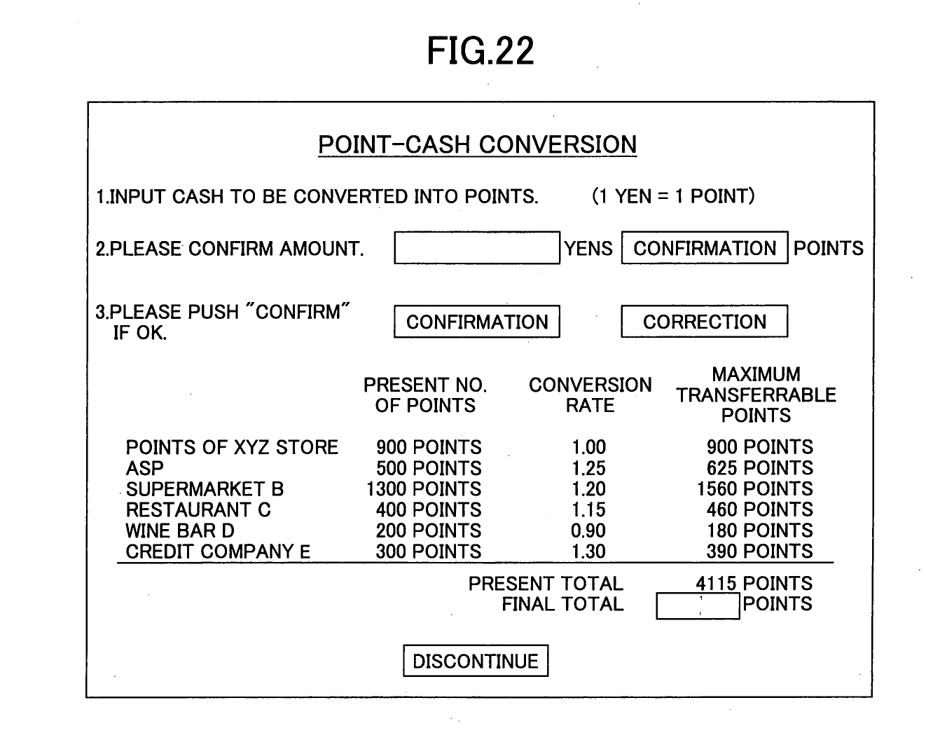

In FIG. 21, a step S81 decides whether or not the “cash-point conversion” button is selected on the initial menu shown in FIG. 5, and the process advances to a step S82 if the decision result in the step S81 is YES. The step S82 displays the petty cash transaction menu shown in FIG. 12, and urges the customer to insert a card if the card which is already inserted for making the financial transaction is different from the card to which the points are to be redistributed. A step S83 displays a cash-point conversion menu shown in FIG. 22, based on the information read from the inserted card, and urges the customer to input the cash to be converted into the points and to confirm the amount of cash to be converted into the points. A step S84 issues the discount ticket, the free ticket or the like from the ticket issuing unit 24, depending on the added points based on the input information, the cash-point conversion and the like. The step S84 also displays the card extraction menu shown in FIG. 8, so as to urge the customer to extract the card from the card reader 25, and the process ends when the card is extracted.

In other words, when the cash is deposited, the amount of cash, the points and a final total of the points, are displayed on the cash-point conversion menu shown in FIG. 22. For the sake of convenience, it is assumed that the same value is indicated for the cash and the corresponding points. Therefore, if the customer wishes to exchange the points for a certain item but the points gained by the customer is insufficient to make the exchange, for example, the customer can add points in a simple manner, so that it is possible to more easily make use of, that is, consume, the points.

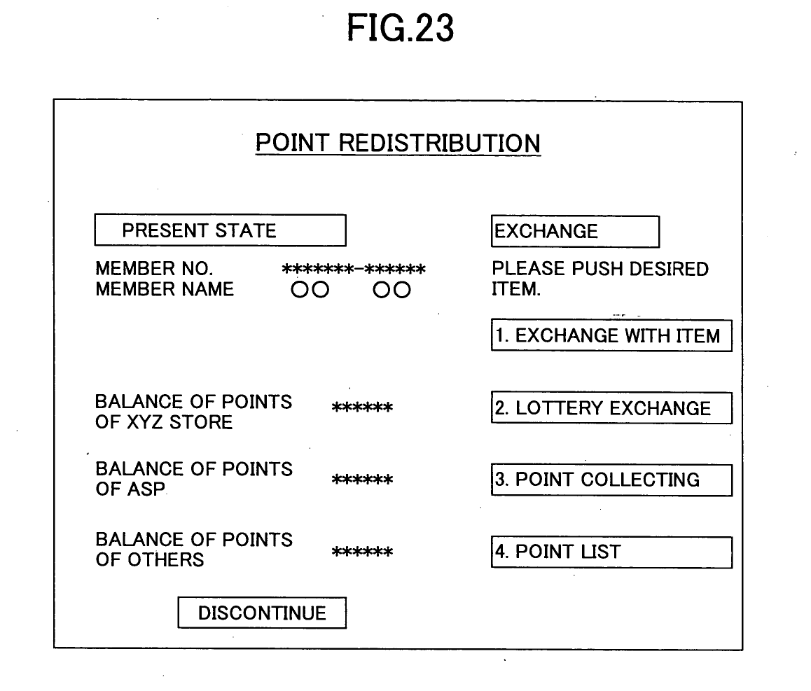

Returning now to the description of FIG. 4, steps S31 though S37 carry out a point redistributing process. The step S31 displays a card insertion menu similar to that shown in FIG. 6, and urges the customer to insert a card, such as a cashing card of the banking establishment and a credit card. When the customer inserts the card into the card reader 25, the step S31 displays the member information input menu, and urges the customer to input the member information such as the PIN. The PIN is authenticated by a known method based on the information read from the card. When the authentication result confirms the customer and the authentication ends, a point redistribution menu shown in FIG. 23 is displayed if the “point redistribution” button is selected on the initial menu shown in FIG. 5, for example. A step S32 urges the customer to select the point redistribution process, that is, to select the type of point exchange. An exchange with an item (item exchange), a lottery exchange, a collection of points (point collecting) and a point list may be selected on the point redistribution menu shown in FIG. 23. When the lottery exchange is selected, the points are increased or decreased by lottery according to a predetermined rate. When the point list is selected, the points presently gained (or held) by the customer and the kinds of points are displayed in the form of a list.

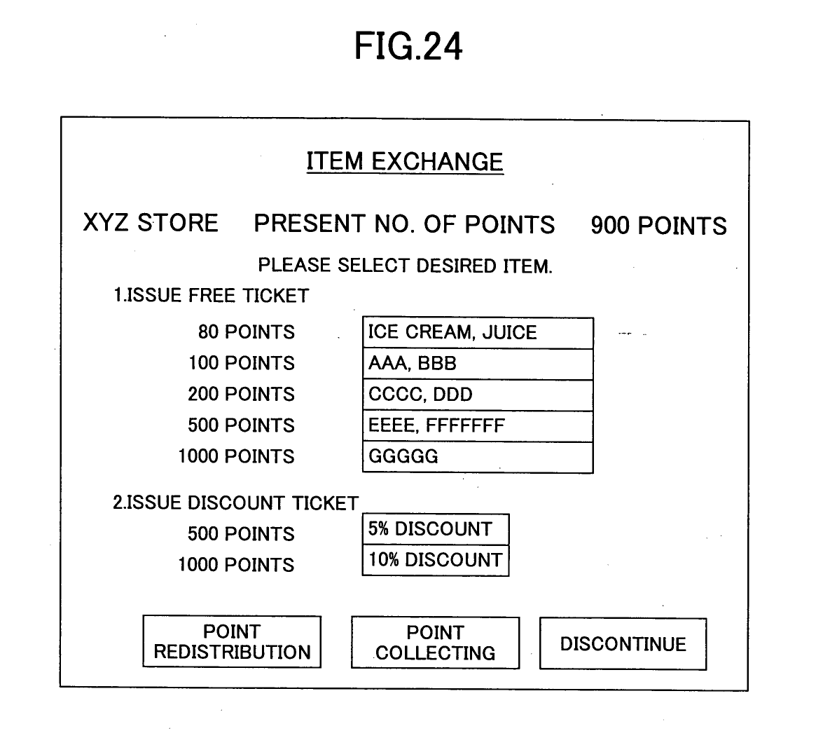

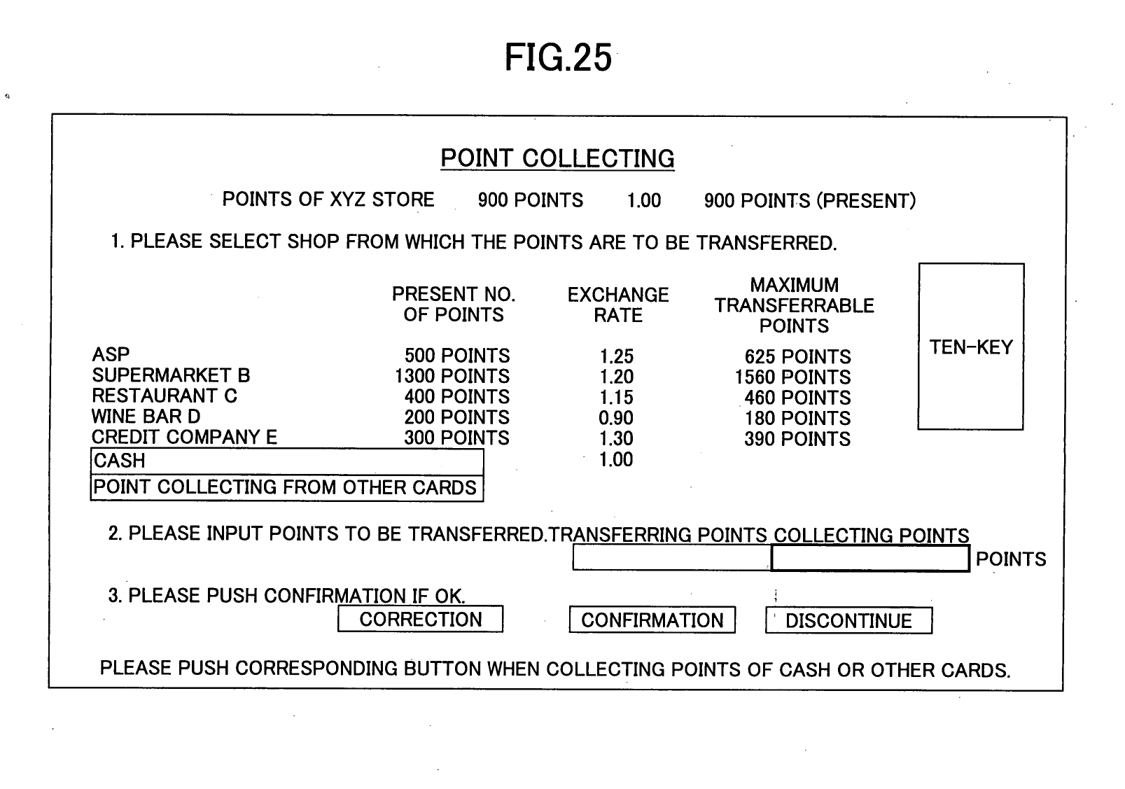

For example, when the “item exchange” is selected on the point redistribution menu shown in FIG. 23, the step S33 displays an item exchange menu shown in FIG. 24, and urges the customer to select the desired item with respect to which the free ticket and/or the discount ticket is to be issued. When the item is selected on the point redistribution menu, a menu requesting the customer to confirm the selection is displayed, so as to urge the customer to input the desired amount (number) of the item if applicable. When the “point collecting” is selected on the point redistribution menu shown in FIG. 23 or the item exchange menu shown in FIG. 24, the step S34 displays a point collecting menu shown in FIG. 25, so as to display the items that are free and/or subject to the discount at the setup location of the terminal equipment 3-N, the items and the points required to make the exchange, the points gained (or held) by the customer and the like. In the case of the point collecting menu shown in FIG. 25, the customer is urged to select a shop to which the points are to be transferred, input the points to the transferred, the confirmation of the transfer and the like. The step S35 adds points to the points gained (or held) by the customer, based on the information which is related to the transfer of the points and is input on the point collecting menu shown in FIG. 25. The step S36 returns the display to the item exchange menu shown in FIG. 24, and urges the customer to select the item for which the free or discount benefit is to be received. The step S37 issues the discount ticket, the free ticket or the like from the ticket issuing unit 24 depending on the information which is related to the benefit selected by the customer, and displays the card extraction menu shown in FIG. 8 so as to urge the customer to extract the card from the card reader 25. The process ends when the customer extracts the card.

When the customer wishes to add 100 or more points of an XYZ store and make the points of the XYZ store 1000 or more points on the point collecting menu shown in FIG. 25, and if the customer selects a wine bar D and inputs “180” points, for example, “1080” points are displayed as the collected points. When the “cash” button is selected, the display switches to the cash-point conversion menu shown in FIG. 11. A “collect points of other cards” button is selected when the customer wishes to collect the points of other member's cards owned by the customer, the points of cards owned by family members of the customer and the like.

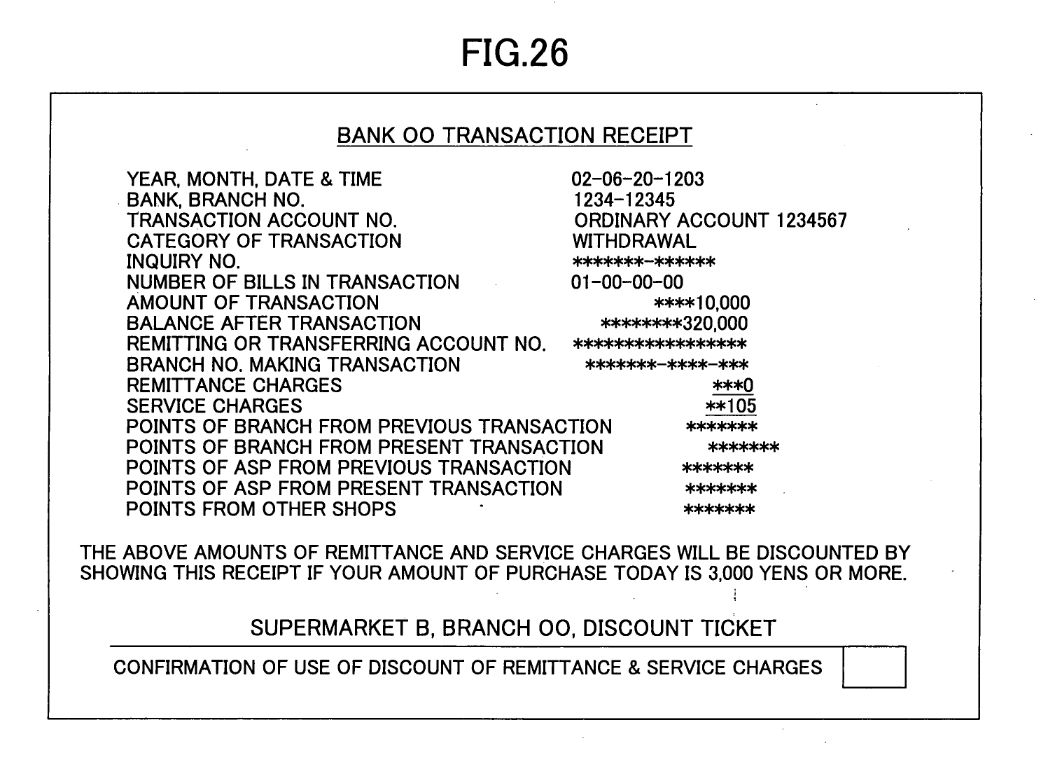

FIGS. 26 through 33 are diagrams for explaining the discount ticket, the free ticket or the like issued by the ticket issuing unit 24. Each of the tickets shown in FIGS. 26 through 33 is recorded with the details of the services and the like subject to the discount or free benefit.

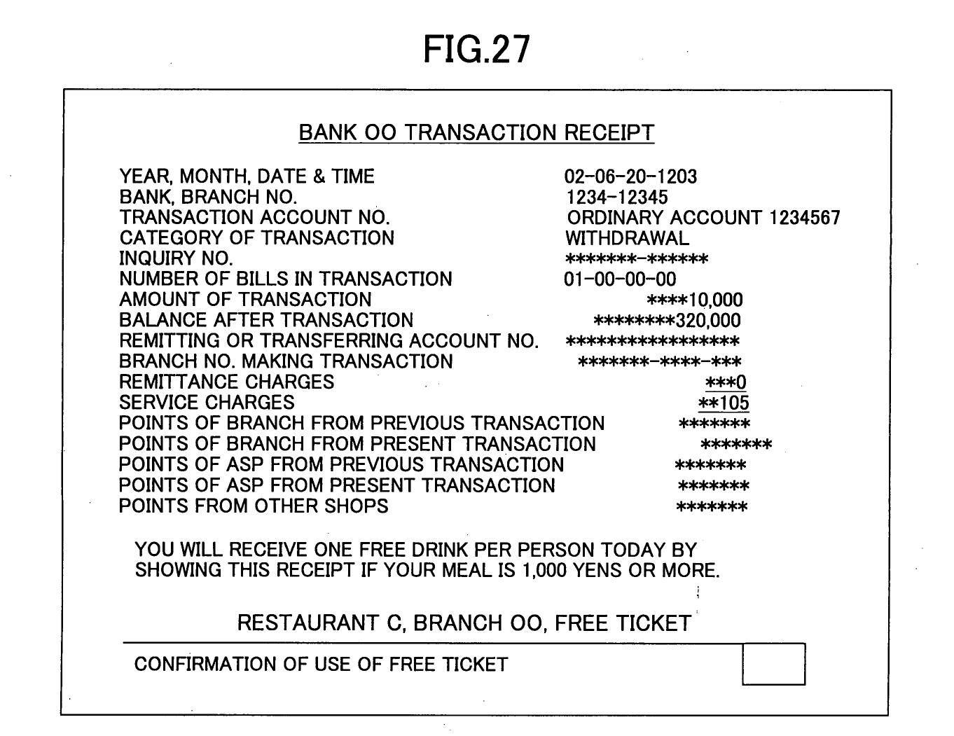

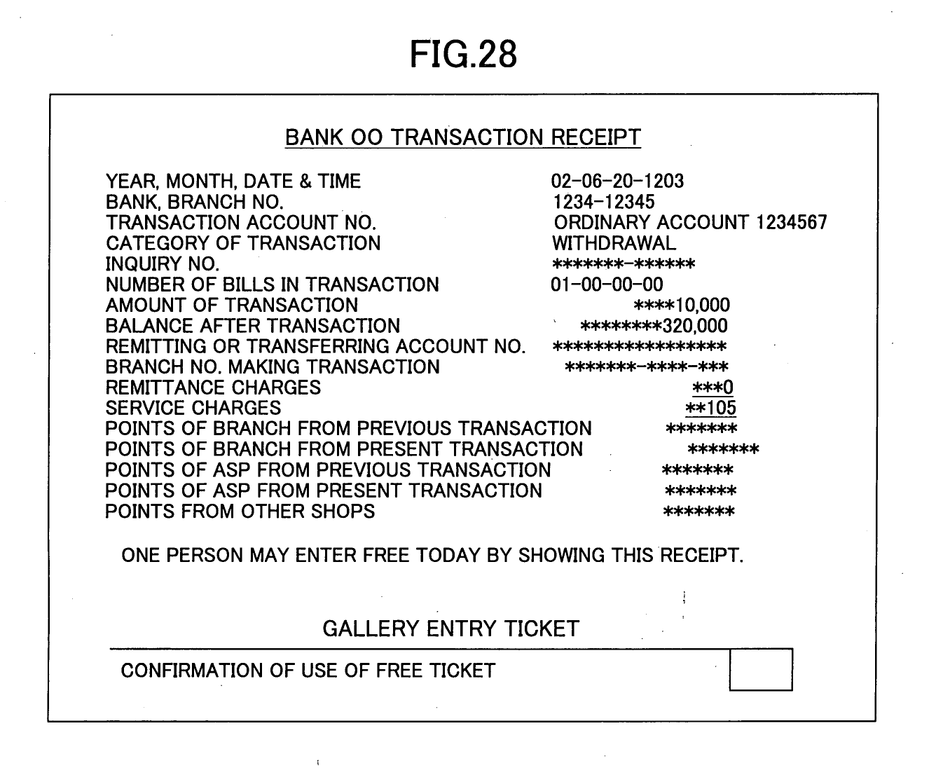

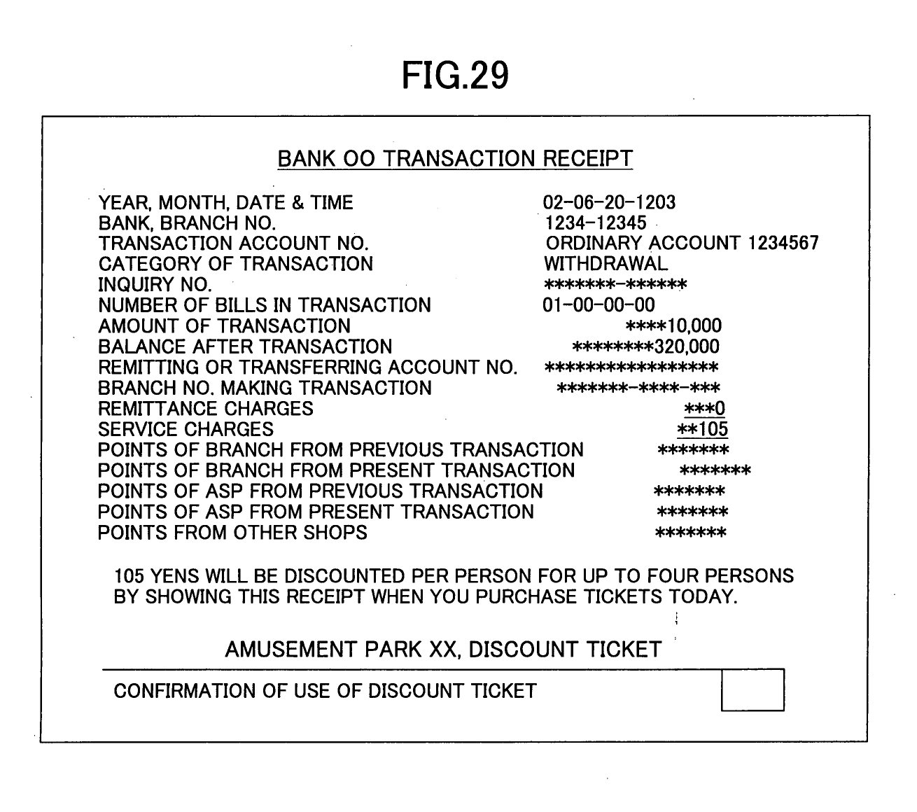

FIG. 26 is a diagram showing an embodiment of a discount ticket of the supermarket B issued in the step S24 shown in FIG. 4, and FIG. 27 is a diagram showing an embodiment of a free ticket of the restaurant C issued in the step S24. In addition, FIG. 28 is a diagram showing an embodiment of an entry ticket for a gallery issued in the step S24, and FIG. 29 is a diagram showing an embodiment of a discount ticket for an amusement park issued in the step S24.

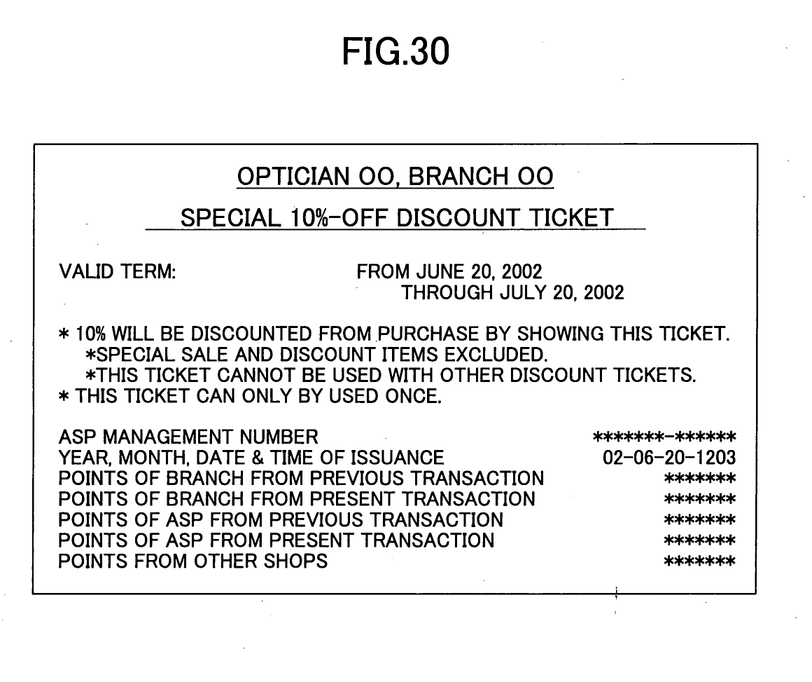

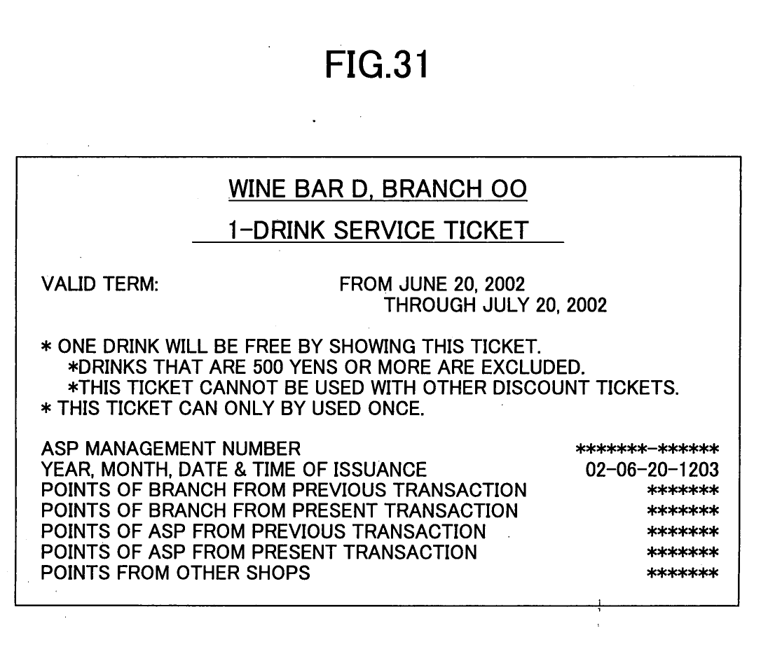

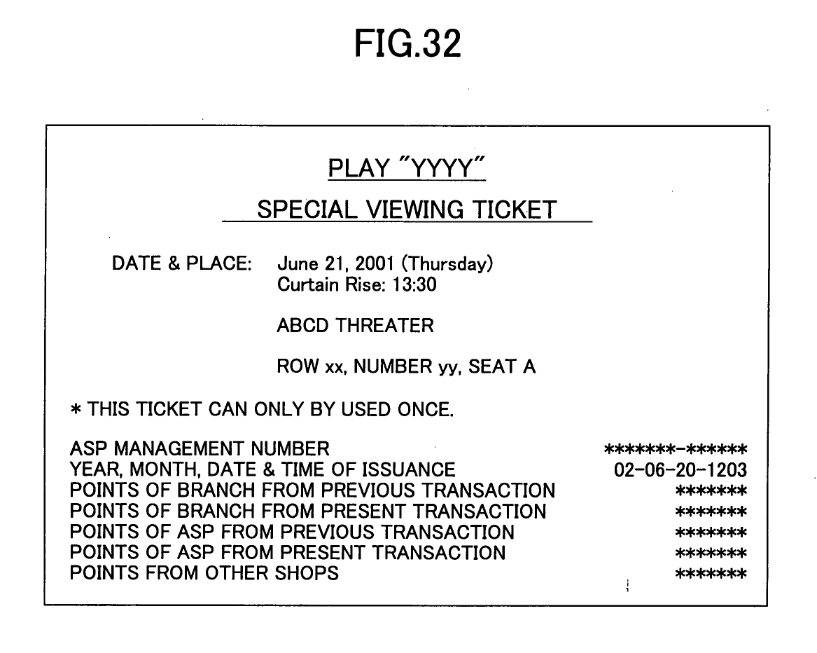

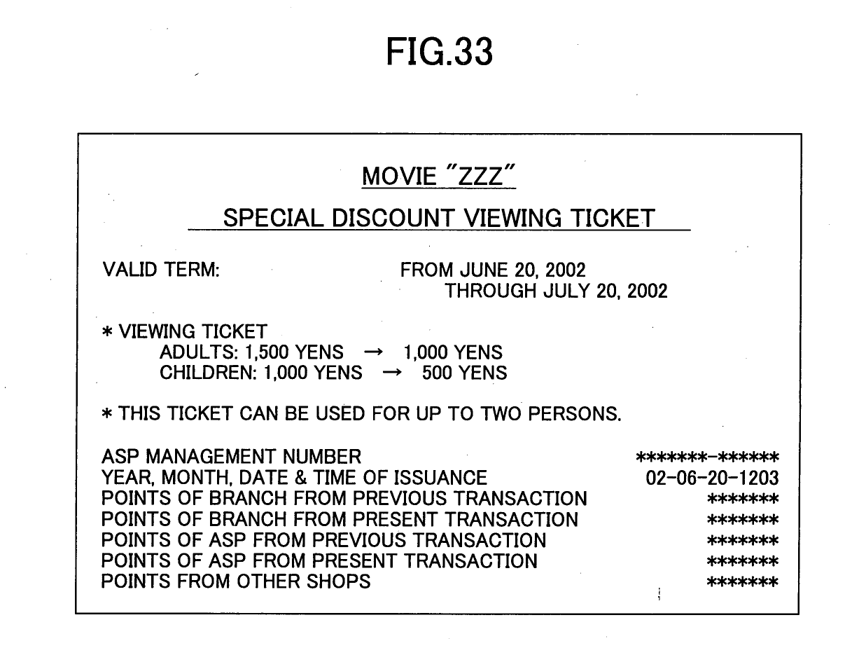

FIG. 30 is a diagram showing an embodiment of a special 10%-off discount ticket issued in the step S37 shown in FIG. 4, and FIG. 31 is a diagram showing an embodiment of a 1-drink service ticket issued in the step S37. Further, FIG. 32 is a diagram showing an embodiment of a special viewing ticket issued in the step S37, and FIG. 33 is a diagram showing an embodiment of a special discount viewing ticket issued in the step S37. Each of the tickets shown in FIGS. 30 through 33 are of the type that is collected when the discount or free service and the like are used.

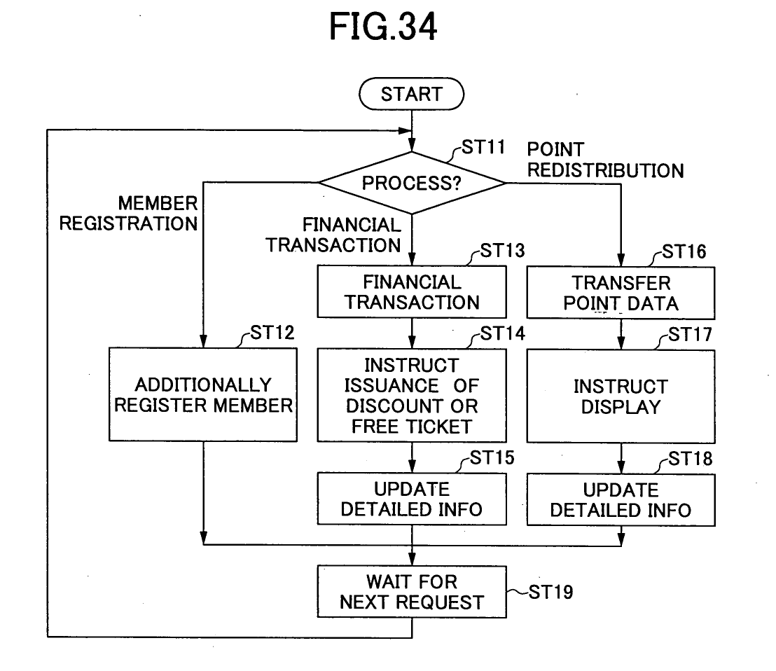

FIG. 34 is a flow chart for explaining a process of the computer 2, that is, the ASP process. In FIG. 34, a step ST11 decides whether the process selected on the initial menu shown in FIG. 5 at the terminal equipment 3-N is the member registration process, the financial transaction or the point redistribution. If the “member registration” button is selected on the initial menu at the terminal equipment 3-N to select the member registration, the process advances to a step ST12 which carries out a process to additionally register the customer (member) based on the information input from the terminal equipment 3-N, and the process thereafter advances to a step ST19 which will be described later.

If a button other than the “member registration” and “point redistribution” buttons are selected on the initial menu at the terminal equipment 3-N to select the financial transaction process (point adding process), the process advances to a step ST13 from the step ST11. The step ST13 carries out a financial transaction requested from the customer, based on the information input from the terminal equipment 3-N. For example, the step ST13 exchanges necessary information with the computer 1-i of the banking establishment having the deposit account and/or the computer 1-i of the banking establishment having the withdrawal account, based on the various information input in the step S72, where i=1 to M, j=1 to M, and i≠j. In the case of a payment, the step ST13 carries out a known withdrawal from the computer 1-j having the withdrawal account, and in the case of a deposit, the step ST13 carries out a known deposit to the computer 1-i having the deposit account. In addition, a step ST14 instructs the terminal equipment 3-N to issue the discount ticket, the free ticket or the like and to eject the card, depending on the points that are added based on the payment and/or deposit and the various information input from the terminal equipment 3-N. Further, a step ST15 updates detailed information related to the. points of the customer managed by the computer 2, based on the financial transaction made by the customer, the item purchased and/or the service used by the customer at the setup location of the terminal 3-N, the issuance of the discount ticket, the free ticket or the like. After the step ST15, the process advances to the step ST19 which will be described later.

If the “point redistribution” button is selected on the initial menu at the terminal equipment 3-N to select the point redistribution process, a step ST16 transfers the detailed information (point data) related to the points of the customer, managed by the computer 2, to the terminal equipment 3-N. A step ST17 instructs the terminal equipment 3-N to display the items subject to the free or discount benefits, the points required to receive the benefits, the points gained (or held) by the customer and the like, depending on a request from the terminal equipment 3-N. A step ST18 instructs the terminal equipment 3-N to issue the discount ticket, the free ticket or the like, depending on a request from the terminal equipment 3-N. In addition, the step ST18 decreases the points of the customer by carrying out a subtraction, depending on the issuance of the discount ticket, the free ticket or the like, and updates the detailed information related to the points of the customer managed by the computer 2. After the step ST18, the process advances to the step ST19.

The step ST19 waits for a next request from an arbitrary terminal equipment of the terminal equipments 3-1 through 3-N, and the process returns to the step ST11 when the next request is received.

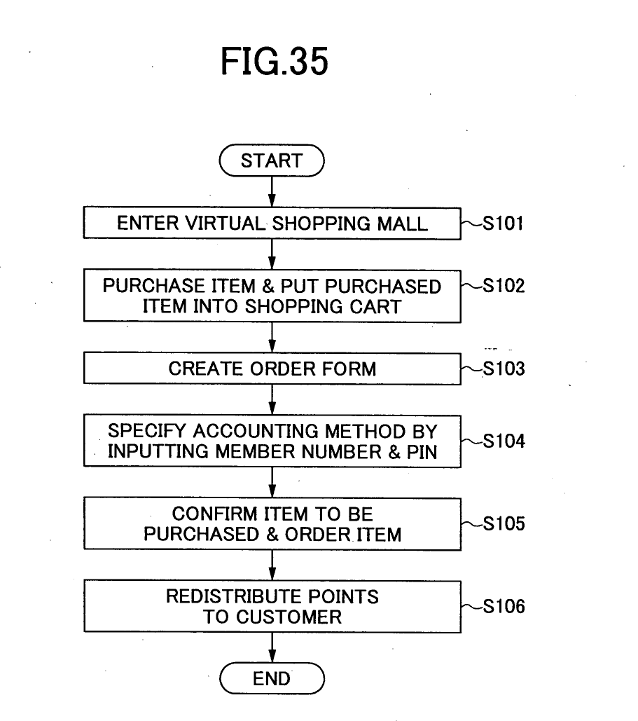

FIG. 35 is a flow chart for explaining a process for a case where the terminal equipment is provided at a virtual location on the Internet. For the sake of convenience, it is assumed that the virtual location (virtual shopping mall) on the Internet is provided in an accessible manner by the computer 2, and that the customer may utilize services such as using a shop within the virtual location from a terminal equipment such as the customer's personal computer and making a financial transaction from a virtual terminal such as the terminal equipment 3-N. The terminal equipment used, such as the customer's personal computer, may be formed by a terminal equipment that is portable and/or is capable of making wireless communication.

In FIG. 35, a step S101 enters the virtual shopping mall on the Internet by a known method, and a step S102 purchases an item at a shop within the virtual shopping mall and puts the purchased item in a shopping cart by a known method. A step S103 fills in and creates an order form related to the item to be purchased by a known method. A step S104 specifies an accounting method (or method of payment) by a known method, by inputting information such as the member number, the PIN, the credit card, and the automatic transfer from the bank account. A step S105 confirms the information related to the item to be purchased and orders the item, by a known method. A step S106 redistributes the benefit (points) to the customer depending on the order of the item, and the process ends.

The redistribution of the benefit in the step S106 is basically similar to the point redistribution process of the steps S31 through S37 shown in FIG. 4. However, since the access is made from the terminal equipment 3-P of the customer in this case, the customer may be requested to input the necessary information from the virtual terminal equipment within the virtual shopping mall, instead of inserting a card. The confirmation of the benefit redistribution may be made on a menu displayed on the virtual terminal equipment or the terminal equipment 3-P. The actual redistribution of the benefit may be received by a real terminal equipment or, the benefit such as the discount ticket and the free ticket may be output from a printer or a recording apparatus which is connected to the terminal equipment 3-P of the customer. Furthermore, since no card is inserted and the extraction of the card does not take place, the customer may be requested to instruct the end of the process from the terminal equipment 3-P, for example. The necessary information that is required in place of the insertion of the card may include the member number, an electronic (e-mail) address, an Internet Protocol (IP) address and the like. A method of inputting such necessary information is not limited to the use of keys, and the necessary information may be read and input by an Optical Character Reader (OCR) which reads a member's card, for example, or may be read and input by a bar code reader which reads a bar code on the member's card, for example. A method of inputting the PIN is also not limited to the use of the keys, and a biometric recognition method using finger prints and the like may be used.

The member registration and the financial transaction may also be made from the terminal equipment 3-P of the customer by a known method.

The member registration is not an essential condition for the present invention, and it is possible make the benefit redistributable to and receivable by any customer having a card of a banking establishment.

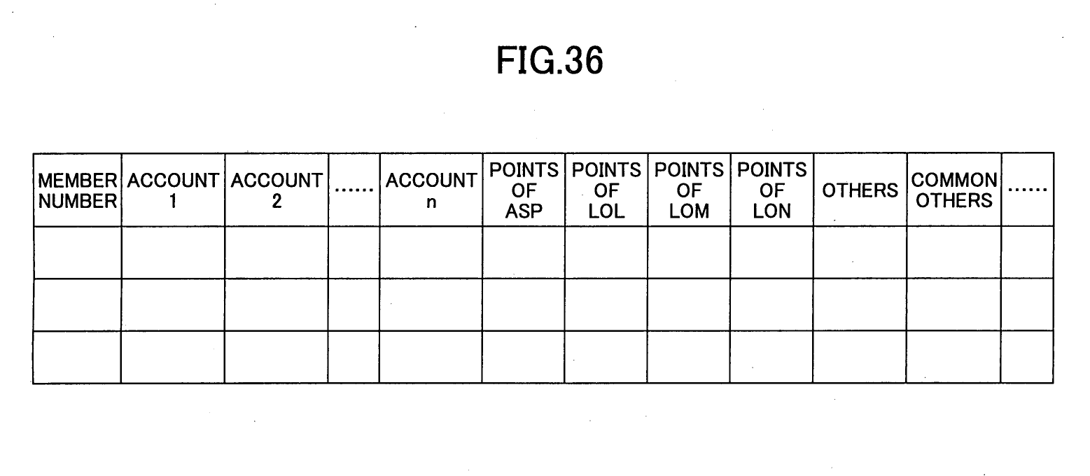

Next, a description will be given of various files or tables managed by the computer 2, that is, the ASP, by referring to FIGS. 36 through 47. The various files or tables described hereunder are stored in the storage unit of the computer 2.

FIG. 36 is a diagram showing an embodiment of a member file. The member file shown in FIG. 36 manages each member and the points of each member. A member number indicates the number which is automatically assigned to a registered customer by the ASP. Accounts 1, 2, . . . , n manage the kind of cards, and the kind of media such as an MS card, a contact type IC card, a non-contact type IC card, a cash card and a credit card. In the case of a bank account, the contents of the account include a bank establishment code, a branch code, an account number, a PIN, a family code and the like. The contents of the account may also include a registered day, month and year. An ASP point indicates the points given by the ASP. LO denotes a location owner (or location manager), and a terminal is set up for each LO. In the case of a net transaction which carries out the transaction via a network such as the Internet, the LO provides a virtual location, that is, a “place”. Accordingly, points of LOL, LOM and LON indicate the points given by the corresponding LOs. Others indicate a most recent date on which the points are given, a number of transactions per month, the points on a closing day and the like, and in the case of a net transaction, the others may further include the e-mail address, the IP address and the like. Common others indicate a temporary pool balance, a direct deposit account file, a member name, a telephone number, address information and the like, and in the case of a net transaction, the common others may further include electronic information of the discount ticket, the free ticket and the like. The points may also be managed by files in the computers 1-1 through 1-M of the banking establishments.

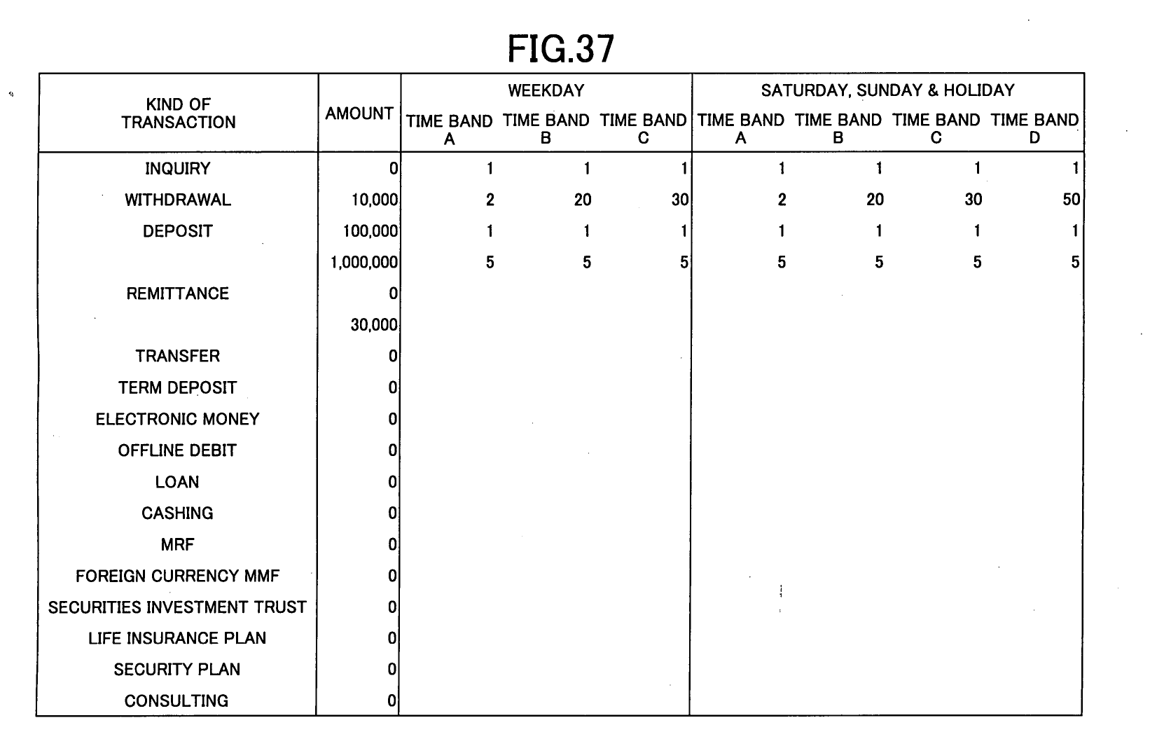

FIG. 37 is a diagram showing an embodiment of an ASP point file. FIG. 37 shows the point file for a case where the number of points given is set differently depending on the kind, the amount of money, the day, the time band and the like of the transaction. By giving the points in this manner, it is possible to promote transactions from the terminal equipments 3-1 through 3-N, average the transactions, and the like. When redistributing the points, the points may be distributed at the location or via the network by taking into consideration the providing cost and the collaboration with the location owner (or location manager). For example, in the case shown in FIG. 37, the number of points given with respect to a withdrawal is different even for the same amount of money withdrawn, depending on the time band of the transaction.

FIG. 37 merely shows an example of a case where the number of points given is set differently depending on the time band and the like, but it is also possible to set the number of points given differently for a real transaction and a net transaction. In addition, the kinds of transactions eligible for receiving the points may of course be different between the real transaction and the net transaction. Therefore, the number of points to be given with respect to each transaction may be set from the point of view of the ASP, and the number of points to be given may be optimized based on various marketing data.

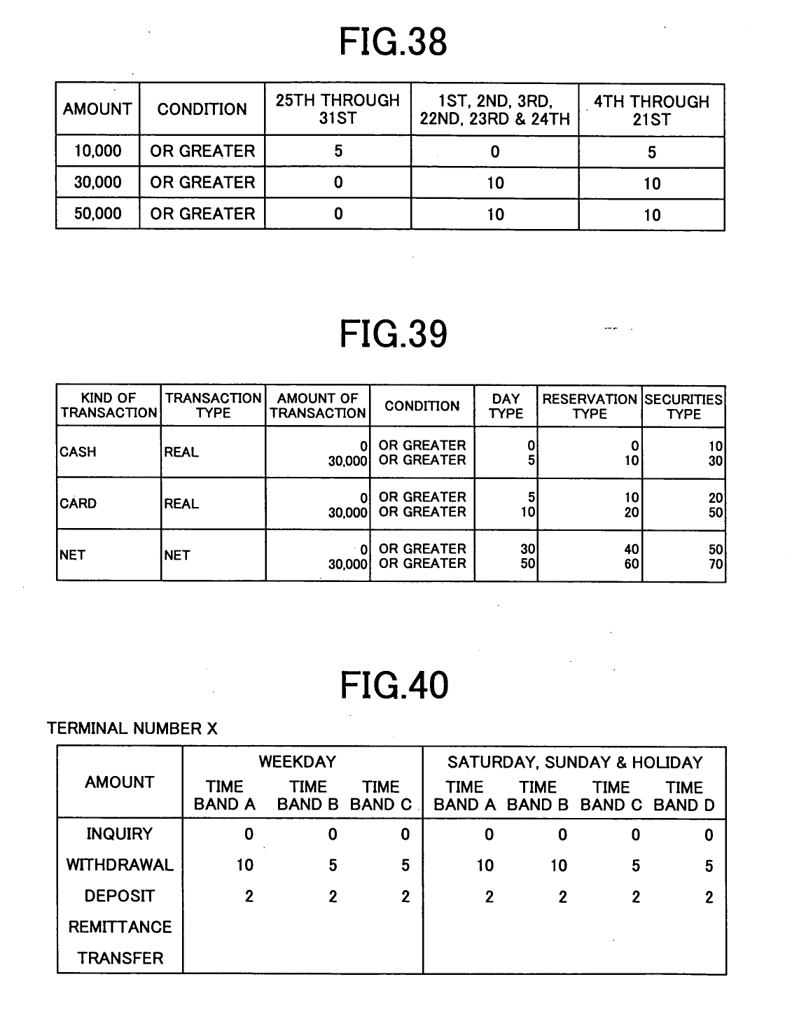

FIG. 38 is a diagram showing another embodiment of the ASP point file. FIG. 38 shows the point file for a case where the number of points given is set differently depending on the date of a cash withdrawal by the real transaction. In this case, it is possible to average the cash transactions occurring on or after the 25th of each month.

FIG. 39 is a diagram showing still another embodiment of the ASP point file. FIG. 39 shows the point file for a case where the number of points given is set differently depending on the transaction type, that is, whether the transaction is a real transaction or a net transaction, so as to cope with diversification of the remittance points and the remittance methods. As the diversification of the remittance method, it is possible to set a day type which specifies a day remittance, a reservation type (or deferred type) which specifies a remittance on a future date, and a securities type which only requires the remittance to be made within a couple of days on a date convenient for the banking establishment, for example. In the case of the securities type, it is possible to set the remittance, that is, the payment for the securities, to be made within 4 business days, for example.

FIG. 40 is a diagram showing an embodiment of a location owner point file. FIG. 40 shows the point file which is used by the location owner (or location manager) for a case where the number of points given is set differently for the terminal equipment 3-N having a terminal number X, depending on the day, the time band and the kind of transaction. The contents of the point file may of course be modified depending on the business classification (or field) of the location owner (or location manager), the customer service strategy, the season and the like.

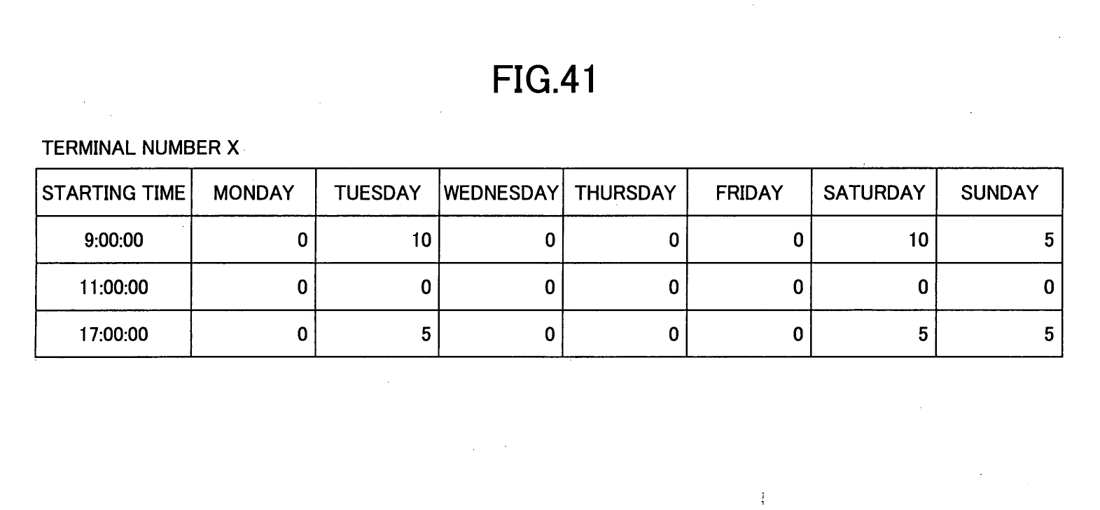

FIG. 41 is a diagram showing another embodiment of the location owner point file. FIG. 41 shows the point file which is used by the location owner (or location manager) for a case where the number of points given is set differently for the terminal equipment 3-N having the terminal number X, depending on the day (or day of week) and the time band.

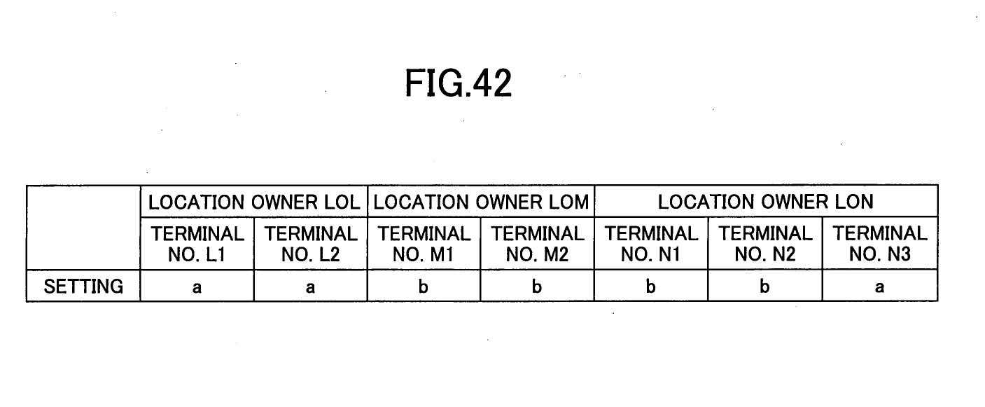

FIG. 42 is a diagram showing an embodiment of a location owner discount file. FIG. 42 shows the discount file which is used by the location owner (or location manager) in order to issue the discount ticket or the free ticket for the financial transaction. A setting “a” indicates that there is no discount ticket, and a setting “b” indicates a free message area for displaying the service discount, 1-drink service, item discount, and the like. In the case shown in FIG. 42, the settings “a” and “b” are made with respect to each terminal equipment having a terminal number (L1, . . . , M1, . . . , N1, . . . ) of each of the location owners (or location managers) LOL, LOM and LON. As shown with respect to the location owner LON, different settings may be made with respect to the terminal equipments of the same location owner depending on the setup location, the state of the shop and the like.

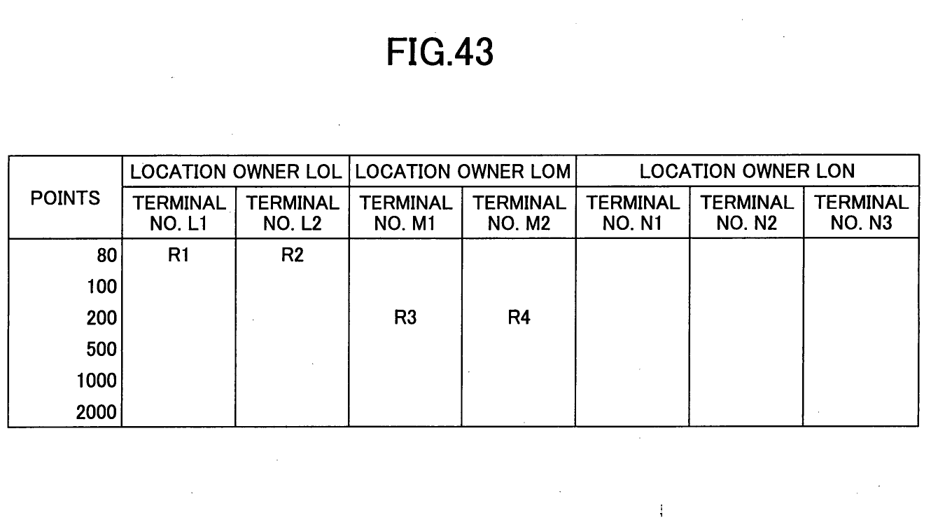

FIG. 43 is a diagram showing an embodiment of a location owner item providing file. The item providing file shown in FIG. 43 is used to select the item at the time of the point redistribution, and the redistribution contents may be set differently even for the same location owner (or location manager). In the case shown in FIG. 43, the terminal equipment of the location owner LOL having the terminal number L1 can issue a free ice cream ticket R1 at 80 points, and the terminal equipment of the location owner LOL having the terminal number L2 can issue a free soft drink ticket at 80 points. In addition, the terminal equipment of the location owner LOM having the terminal number M1 can issue a free download ticket R3 for music distribution or game software download at 200 points, and the terminal equipment of the location owner LOM having the terminal number M2 can issue a movie viewing ticket R4 at 200 points.

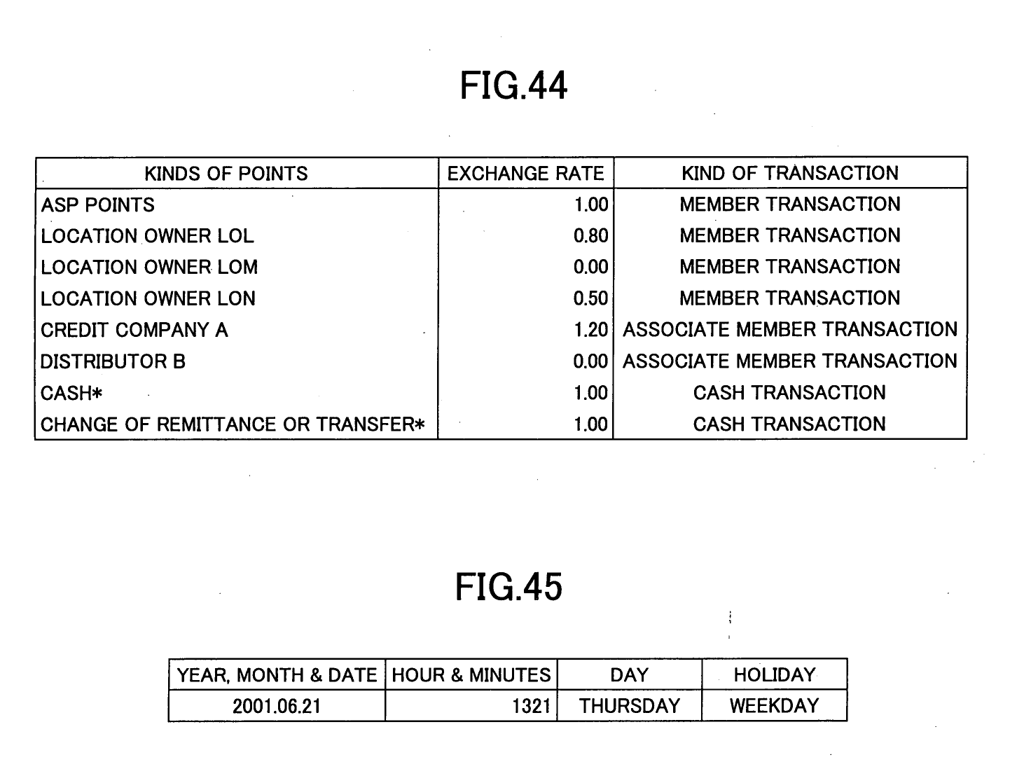

FIG. 44 is a diagram showing an embodiment of a point exchange file. The point exchange file shown in FIG. 44 sets the point exchange rate depending on the policy of the location owner (or location manager). The point exchange rate may be changed non-periodically during events (or campaigns), discount sale or the like. The point exchange rate may also be changed depending on the time band, for example.

The point exchange file may be associated with an external point system which is different and is provided by a credit card company or the like. The exchange rate may be set to a value exceeding 1 as in the case of a credit A, and may also be set to 0 (non-exchangeable) as in the case of a distribution B shown in FIG. 44. The point exchange file may also be used to manage the cash-point conversion when the points are insufficient or a change needs to be provided when making the cash remittance. In the point exchange file shown in FIG. 44, mutual exchange is possible among different kinds of points. However, it is of course possible to permit only a one-way exchange so that a first kind of points may be exchanged into a second kind of points but not vice versa.

FIG. 45 is a diagram showing an embodiment of a calendar file. The calendar file shown in FIG. 45 manages calendar data such as the year, month and day, the hour and minutes, the day of week, the holiday and the like.

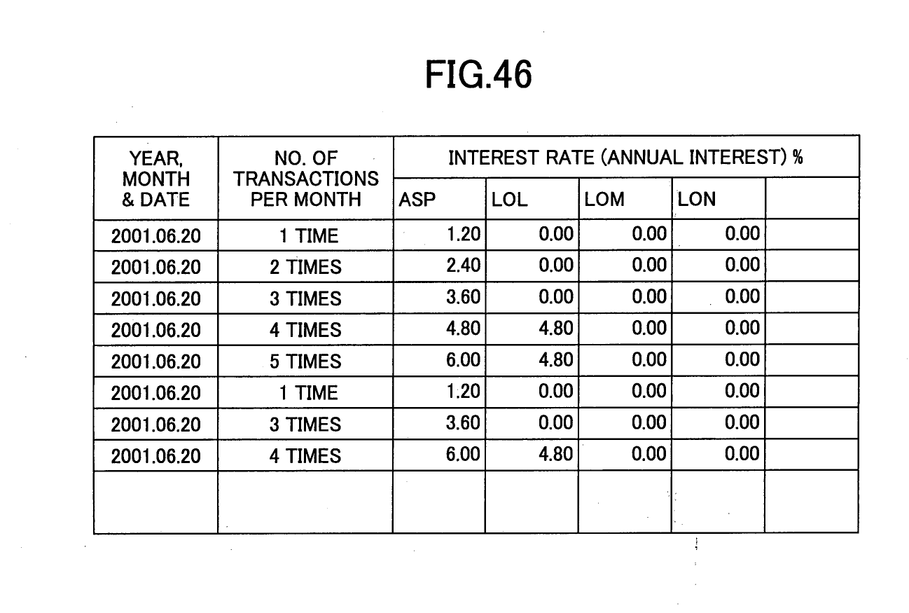

FIG. 46 is a diagram showing an embodiment of an interest rate file. The interest rate file shown in FIG. 46 is used to give interests with respect to the points. The method of giving interests is not limited to a specific method, but for example, the interest may be added on a specific day such as a closing day of each month depending on the balance of the points and the number of transactions and the like made. Moreover, with respect to the balance of the points exceeding a certain period (or expiry date), it is also possible to add a negative interest so as to reduce the points.

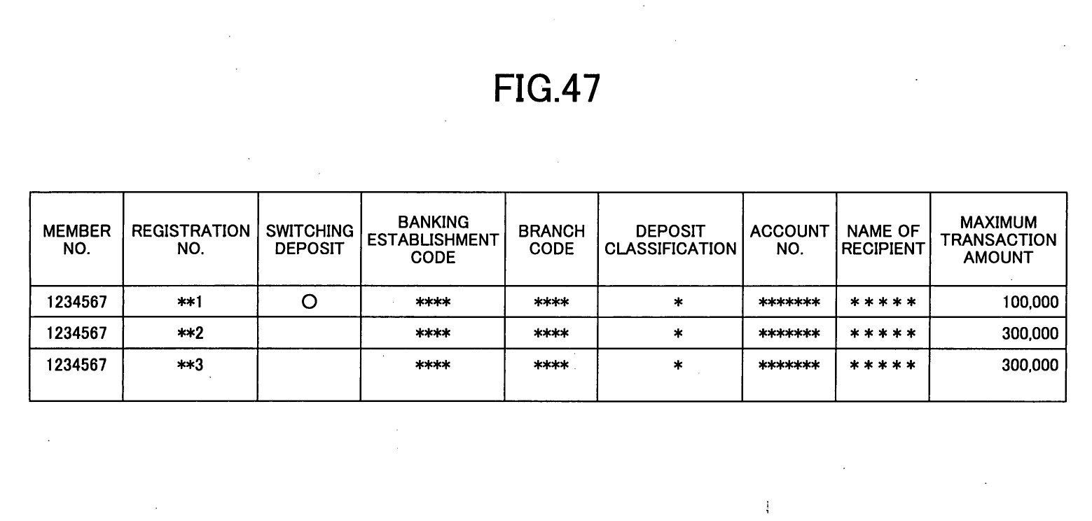

FIG. 47 is a diagram showing an embodiment of a deposit account and remittance account file. The deposit account and remittance account file shown in FIG. 47 is used when consecutively making deposit switching, remittance and the like. In the case shown in FIG. 47, a registration number **1 indicates the account of the banking establishment to which the deposit is to be switched, and registration numbers **2 and **3 indicate the accounts of the banking establishments to which the remittance is to be made. If necessary, it is possible to set a maximum transaction amount per transaction, a maximum transaction amount per day, a maximum transaction amount per month, and the like.

Further, the present invention is not limited to these embodiments, but various variations and modifications may be made without departing from the scope of the present invention.

What is claimed is

1. A benefit redistributing method comprising the steps of:
giving a first benefit to a customer depending on a financial transaction between the customer and a banking establishment using a terminal equipment within an arbitrary location;
giving a second benefit to the customer depending on a use of a service and/or a purchase of an item by the customer within the arbitrary location, said first and second benefits being issued by mutually different entities; and
managing the first and second benefits and providing a second benefit in exchange for the first benefit or, providing a first benefit in exchange for the second benefit, to the user depending on a selection made by the user.

2. The benefit redistributing method as claimed in claim 1, further comprising the step of:
issuing, from the terminal equipment, a recording medium recorded with the first and second benefits.

3. A terminal equipment provided within a location, comprising:
a part configured to perform a financial transaction between a customer and a banking establishment;
a part configured to input service information related to a service used by the customer within the location and/or purchase information related to a purchase made by the customer within the location;
a part configured to notify to the customer a first benefit given to the customer from the banking establishment depending on the transaction made by the customer and a second benefit given to the customer from a location manager depending on the service used and/or the purchase made by the customer within the location; and
a part configured to send an instruction to convert the first benefit into a second benefit or the second benefit into a first benefit based on a request from the customer, said instruction being set to a host via a communication line.

4. A computer-readable storage medium which stores a program for causing a computer to issue first and second benefits as points and centrally control the points, said program comprising:
a procedure causing the computer to issue points of the first benefit to a customer from a banking establishment depending on a financial transaction between the customer and the banking establishment using a terminal equipment within an arbitrary location;
a procedure causing the computer to issue points of the second benefit to the customer from a location manager depending on a use of a service and/or a purchase of an item by the customer within the arbitrary location;
a procedure causing the computer to store the points of the first benefit and the points of the second benefit in a storage unit for each customer; and
a procedure causing the computer to convert the first benefit stored in the storage unit into a second benefit or to convert the second benefit stored in the storage unit into a first benefit, by referring to a table that is configured to convert the first benefit into the second benefit or to converting the second benefit into the first benefit, based on a request from the customer.

5. The computer-readable storage medium as claimed in claim 4, wherein the arbitrary location is selected from a group consisting of real locations and virtual locations on the Internet.

6. A benefit managing apparatus, coupled to a computer of a bank establishment and to a terminal equipment provided within a location, for managing benefits depending on transactions made by a customer, said benefit managing apparatus comprising:
a storage unit configured to store a first benefit issued depending on a financial transaction that is made by use of the terminal equipment within the location and a second benefit issued depending on a use of a service and/or a purchase of an item within the location, for each customer;
a table configured to convert the first benefit into a second benefit or to convert the second benefit into a first benefit; and
a controller configured to convert the first benefit of a user stored in the storage unit into the second benefit or to convert the second benefit of the user stored in the storage unit into the first benefit, by referring to the table based on a request from the customer.

7. A benefit managing apparatus, coupled to a computer of a banking establishment and to each terminal equipment provided within a plurality of locations, for managing benefits depending on transactions made by a customer, said benefit managing apparatus comprising:
a storage unit configured to store a first benefit issued depending on a financial transaction that is made by use of a terminal equipment within one of the plurality of locations, and a second benefit issued depending on a use of a service and/or a purchase of an item within the plurality of locations independently for each of the plurality of locations, said first and second benefits being stored in the storage unit for each customer;
a table configured to convert the first benefit into a second benefit or to convert the second benefit within a specific location into a second benefit within an other location; and
a controller configured to convert the first benefit of a user stored in the storage unit into the second benefit or to convert the second benefit of the user within the specific location stored in the storage unit into the second benefit within the other location, by referring to the table based on a request from the customer.
